(19) United States
(12) Patent Application Publication
(10) Pub. No.: US 2024/0031765 A1
(43) Pub. Date: Jan. 25, 2024

(54) AUDIO SIGNAL ENHANCEMENT

(71) Applicant: QUALCOMM Incorporated, San Diego, CA (US)

(72) Inventors: Isaac Garcia MUNOZ, San Diego, CA (US); Shankar THAGADUR SHIVAPPA, San Diego, CA (US); Mason DAVIS, Oakland, CA (US); Alex TUNG, San Diego, CA (US); Dinesh RAMAKRISHNAN, Irvine, CA (US); Andre SCHEVCIW, San Diego, CA (US)

(21) Appl. No.: 17/814,783

(22) Filed: Jul. 25, 2022

(51) Int. Cl. H04S 7/00; G10L 19/008; G06V 40/16; H04S 1/00

(52) U.S. Cl. CPC H04S 7/305; G10L 19/008; G06V 40/161; H04S 1/007; H04S 7/303; H04S 2400/15; H04S 2420/01

(57) ABSTRACT

A device includes a processor configured to perform signal enhancement of an input audio signal to generate an enhanced mono audio signal. The processor is also configured to mix a first audio signal and a second audio signal to generate a stereo audio signal. The first audio signal is based on the enhanced mono audio signal.

### I. FIELD

The present disclosure is generally related to audio signal enhancement.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications (e.g., a web browser application), that can be used to access the Internet. As such, these devices can include significant computing capabilities.

Such computing devices often incorporate functionality to process an audio signal. For example, the audio signal may represent sounds captured by one or more microphones or correspond to decoded audio data. Such devices may perform signal enhancement, such as noise suppression, to generate an enhanced audio signal. The signal enhancement (e.g., noise suppression) can remove context from the enhanced audio signal and introduce artifacts that reduce audio quality.

### III. SUMMARY

According to one implementation of the present disclosure, a device includes a processor configured to perform signal enhancement of an input audio signal to generate an enhanced mono audio signal. The processor is also configured to mix a first audio signal and a second audio signal to generate a stereo audio signal. The first audio signal is based on the enhanced mono audio signal.

According to another implementation of the present disclosure, a method includes performing, at a device, signal enhancement of an input audio signal to generate an enhanced mono audio signal. The method also includes mixing, at the device, a first audio signal and a second audio signal to generate a stereo audio signal. The first audio signal is based on the enhanced mono audio signal.

According to another implementation of the present disclosure, a non-transitory computer-readable medium includes instructions that, when executed by one or more processors, cause the one or more processors to perform signal enhancement of an input audio signal to generate an enhanced mono audio signal. The instructions, when executed by the one or more processors, also cause the one or more processors to mix a first audio signal and a second audio signal to generate a stereo audio signal. The first audio signal is based on the enhanced mono audio signal.

According to another implementation of the present disclosure, an apparatus includes means for performing signal enhancement of an input audio signal to generate an enhanced mono audio signal. The apparatus also includes means for mixing a first audio signal and a second audio signal to generate a stereo audio signal. The first audio signal is based on the enhanced mono audio signal.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1A is a block diagram of a particular illustrative aspect of a system operable to perform audio signal enhancement, in accordance with some examples of the present disclosure.

FIG. 1B is a diagram of an illustrative implementation of a signal enhancer of the system of FIG. 1A that is operable to perform noise suppression, in accordance with some examples of the present disclosure.

FIG. 1C is a diagram of another illustrative implementation of the signal enhancer of the system of FIG. 1A that is operable to perform audio zoom, in accordance with some examples of the present disclosure.

FIG. 1D is a diagram of another illustrative implementation of the signal enhancer of the system of FIG. 1A that is operable to perform beamforming, in accordance with some examples of the present disclosure.

FIG. 1E is a diagram of an illustrative implementation of the signal enhancer of the system of FIG. 1A that is operable to perform dereverberation, in accordance with some examples of the present disclosure.

FIG. 1F is a diagram of another illustrative implementation of the signal enhancer of the system of FIG. 1A that is operable to perform source separation, in accordance with some examples of the present disclosure.

FIG. 1G is a diagram of another illustrative implementation of the signal enhancer of the system of FIG. 1A that is operable to perform bass adjustment, in accordance with some examples of the present disclosure.

FIG. 1H is a diagram of another illustrative implementation of the signal enhancer of the system of FIG. 1A that is operable to perform equalization, in accordance with some examples of the present disclosure.

FIG. 2A is a diagram of an illustrative implementation of an audio mixer of the system of FIG. 1A, in accordance with some examples of the present disclosure.

FIG. 2B is a diagram of another illustrative implementation of an audio mixer of the system of FIG. 1A, in accordance with some examples of the present disclosure.

FIG. 2C is a diagram of another illustrative implementation of an audio mixer of the system of FIG. 1A, in accordance with some examples of the present disclosure.

FIG. 3A is a diagram of another illustrative implementation of an audio mixer of the system of FIG. 1A, in accordance with some examples of the present disclosure.

FIG. 3B is a diagram of another illustrative implementation of an audio mixer of the system of FIG. 1A, in accordance with some examples of the present disclosure.

FIG. 3C is a diagram of another illustrative implementation of an audio mixer of the system of FIG. 1A, in accordance with some examples of the present disclosure.

FIG. 4A is a diagram of another illustrative implementation of an audio mixer of the system of FIG. 1A, in accordance with some examples of the present disclosure.

FIG. 4B is a diagram of another illustrative implementation of an audio mixer of the system of FIG. 1A, in accordance with some examples of the present disclosure.

FIG. 4C is a diagram of another illustrative implementation of an audio mixer of the system of FIG. 1A, in accordance with some examples of the present disclosure.

FIG. 5A is a diagram of another illustrative implementation of an audio mixer of the system of FIG. 1A, in accordance with some examples of the present disclosure.

FIG. 5B is a diagram of another illustrative implementation of an audio mixer of the system of FIG. 1A, in accordance with some examples of the present disclosure.

FIG. 5C is a diagram of another illustrative implementation of an audio mixer of the system of FIG. 1A, in accordance with some examples of the present disclosure.

FIG. 6A is a diagram of another illustrative implementation of an audio mixer of the system of FIG. 1A, in accordance with some examples of the present disclosure.

FIG. 6B is a diagram of another illustrative implementation of an audio mixer of the system of FIG. 1A, in accordance with some examples of the present disclosure.

FIG. 6C is a diagram of another illustrative implementation of an audio mixer of the system of FIG. 1A, in accordance with some examples of the present disclosure.

FIG. 7 illustrates an example of a device operable to perform audio signal enhancement of audio signals that are based on encoded data received from another device, in accordance with some examples of the present disclosure.

FIG. 8 illustrates an example of a device operable to transmit encoded data that is based on an enhanced audio signal, in accordance with some examples of the present disclosure.

FIG. 9 illustrates an example of an integrated circuit operable to perform audio signal enhancement, in accordance with some examples of the present disclosure.

FIG. 10 is a diagram of a mobile device operable to perform audio signal enhancement, in accordance with some examples of the present disclosure.

FIG. 11 is a diagram of a headset operable to perform audio signal enhancement, in accordance with some examples of the present disclosure.

FIG. 12 is a diagram of a wearable electronic device operable to perform audio signal enhancement, in accordance with some examples of the present disclosure.

FIG. 13 is a diagram of a voice-controlled speaker system operable to perform audio signal enhancement, in accordance with some examples of the present disclosure.

FIG. 14 is a diagram of a camera operable to perform audio signal enhancement, in accordance with some examples of the present disclosure.

FIG. 15 is a diagram of a headset, such as a virtual reality, mixed reality, or augmented reality headset, operable to perform audio signal enhancement, in accordance with some examples of the present disclosure.

FIG. 16 is a diagram of a first example of a vehicle operable to perform audio signal enhancement, in accordance with some examples of the present disclosure.

FIG. 17 is a diagram of a second example of a vehicle operable to perform audio signal enhancement, in accordance with some examples of the present disclosure.

FIG. 18 is a diagram of a particular implementation of a method of audio signal enhancement that may be performed by the device of FIG. 1A, in accordance with some examples of the present disclosure.

FIG. 19 is a block diagram of a particular illustrative example of a device that is operable to perform audio signal enhancement, in accordance with some examples of the present disclosure.

### V. DETAILED DESCRIPTION

Various devices perform signal enhancement, such as noise suppression, to generate enhanced audio signals. The signal enhancement (some examples include noise suppression, audio zoom, beamforming, dereverberation, source separation, bass adjustment, equalization) can remove audio context from the enhanced audio signal. Audio context in the present disclosure may generally refer to one or more audio signals or signal components which provide audible spatial and/or environmental information for the enhanced audio signal. For example, signal enhancement can be performed on an audio signal captured via microphones of a device during a call to generate an enhanced audio signal without background sounds (e.g., as a result of noise suppression of the audio signal). A listener of the enhanced audio signal, in the absence of the background sounds, cannot determine whether a speaker is in a busy market or an office. The signal enhancement (e.g., noise suppression) can also introduce artifacts that reduce audio quality. For example, speech in the enhanced audio signal can sound choppy.

Recently, signal enhancement using one or more generative networks has been introduced. Specifically, so-called generative adversarial networks (GAN) may be used to generate audio signals, such as speech signals, with improved signal quality, e.g., with increased signal-to-noise-ratio or even without any background sounds. In a GAN, a generative network may generate candidates for data, such as elements (e.g., words, phonemes, etc.) of a speech signal, while a discriminative network evaluates the candidates. Signal enhancement in the present disclosure may process one or more input audio signals using at least one generative network (e.g., a GAN) to generate one or more enhanced mono audio signals.

Specifically, the one or more input signals may be audio signals captured by one or more microphones in a soundscape that includes a source of a primary (target) audio signal such as a speech signal, e.g., uttered by a person, and one or more sources of secondary (unwanted) audio signals, e.g., other speech signals, directional noise, diffuse noise, etc. Signal enhancement in the present disclosure may refer to at least partially removing the secondary audio signals from the input audio signals. As described above, in some examples, the secondary audio signals may be removed using one or more generative networks.

Alternatively or additionally, noise suppression by signal filtering, audio zoom, beamforming, dereverberation, source separation, bass adjustment, and/or equalization may be applied when performing signal enhancement. For example, signal enhancement in the present disclosure may refer to increasing the gain of the target signal (e.g., the speech signal), lowering the gain of the unwanted audio signals, or both, to perform an audio zoom operation. As described above, in some examples, the gain of the target signal may be increased based on using one or more generative networks. In addition, as described above, in some examples, the gain of the unwanted audio signals may be decreased based on using one or more generative networks.

One way to perform an audio zoom operation is to perform a beamforming operation that includes generating a virtual audio beam formed by two or more microphones in the direction of the primary (target) audio signal and/or a null beam in the direction of the secondary (unwanted) audio signals. Thus, signal enhancement in the present disclosure may also refer to at least performing an audio zoom operation. As described above, in some examples, the zoom operations to increase perceptibility of the target signal may be based on using one or more generative networks.

Moreover, signal enhancement in the present disclosure may also refer to generating a virtual audio beam in the direction of the target signal and/or a null beam in the direction of unwanted sound signals. As described within this disclosure, in some examples, beamforming may focus on the target signal using one or more generative networks. In other examples within this disclosure, the unwanted signals may be removed based on using one or more generative networks.

In another example, a mixture of audio signals includes different types of sounds (e.g., speech signals, directional noise, diffuse noise, non-stationary noise, speech from multiple speakers, etc.). Signal enhancement in the present disclosure may also refer to source separation, where the mixture of audio signals are separated from each other. In other examples within this disclosure, the source separation of a mixture of audio signals may be based on using one or more generative networks.

In some examples, an audio signal, such as music audio, includes various frequency components. Signal enhancement in the present disclosure may refer to equalization, where balance of the frequency components is adjusted. In other examples within this disclosure, the equalization of frequency components of an audio signal may be based on using one or more generative networks.

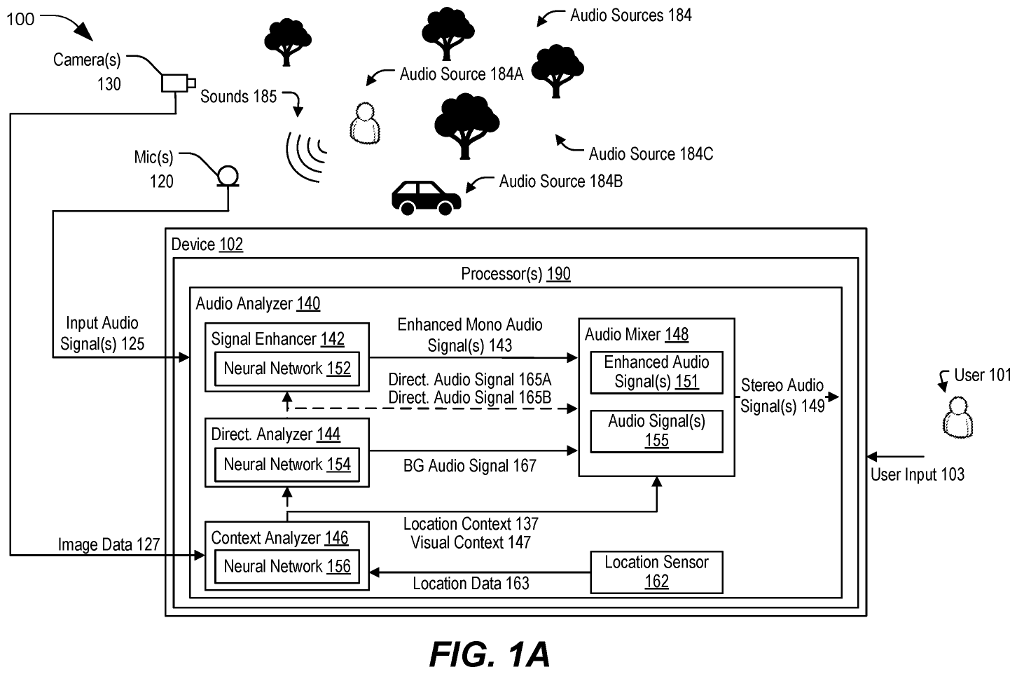

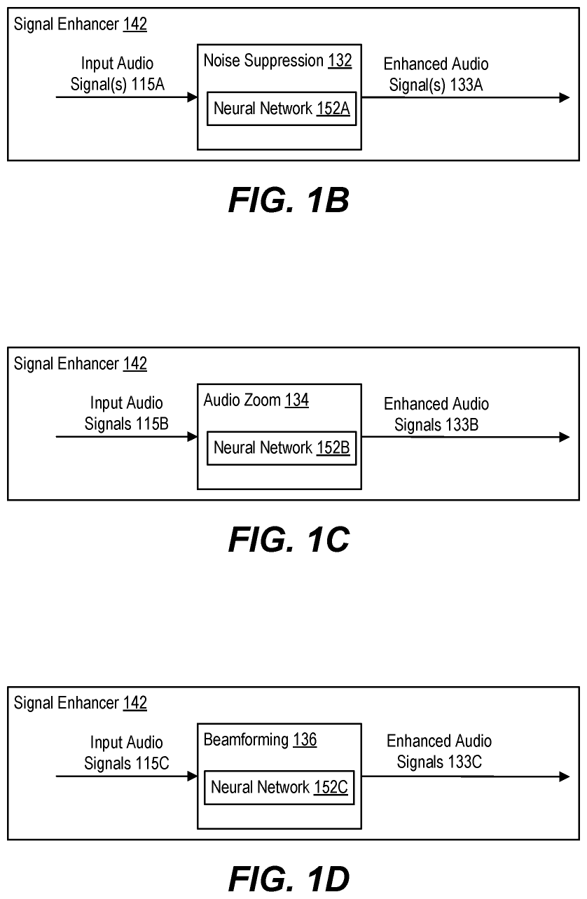

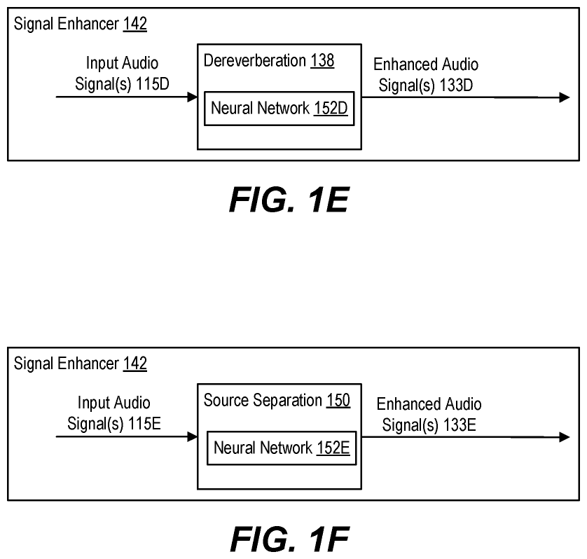

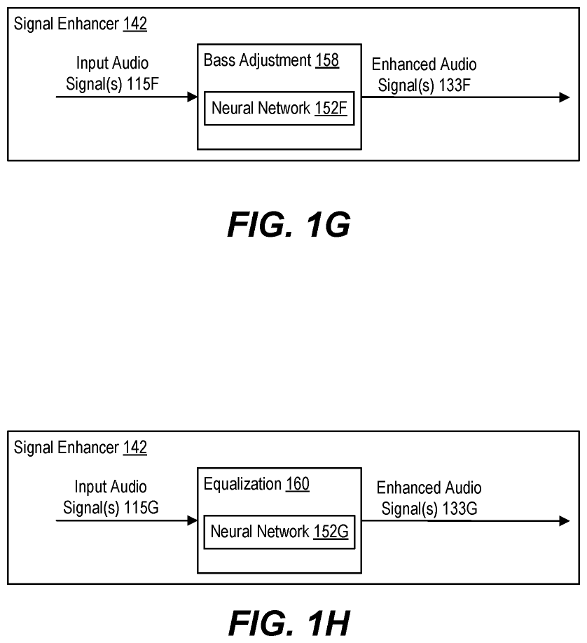

Furthermore, generative audio techniques may be used to generate an enhanced mono audio signal. In some examples, the enhanced mono audio signal may be a noise suppressed speech signal (e.g., a speech signal captured by one or more microphones or decoded from encoded audio data), wherein noise has been partially or completely removed from the corresponding one or more input audio signals. As mentioned above, the noise suppression may involve one or more generative networks (e.g., GANs), as further described with respect to FIGS. 1A-1B. Thus, the enhanced mono audio signal may be a mono speech signal with noise suppressed by application of one or more speech generative networks.

In some examples, the enhanced mono audio signal may be an audio zoomed signal (e.g., a target signal captured by one or more microphones or decoded from encoded audio data), wherein the gain of the unwanted audio signals has been reduced, the gain of the target signal has been increased, or both. As mentioned above, the audio zoom may involve one or more generative networks (e.g., GANs), as further described with respect to FIGS. 1A and 1C. Thus, the enhanced mono audio signal may be a mono speech signal with audio zoomed by application of one or more speech generative networks.

In some examples, the enhanced mono audio signal may be a beamformed signal (e.g., a target signal captured by one or more microphones or decoded from encoded audio data), wherein a virtual audio beam is formed by two or more microphones in the direction of the primary (target) audio signal and/or a null beam is formed in the direction of the secondary (unwanted) audio signals. As mentioned above, the beam forming may involve one or more generative networks (e.g., GANs), as further described with respect to FIGS. 1A and 1D. Thus, the enhanced mono audio signal may be a mono speech signal with beamformed audio by application of one or more speech generative networks.

In some examples, the enhanced mono audio signal may be a dereverberated signal (e.g., a speech signal captured by one or more microphones or decoded from encoded audio data), wherein reverberation has been partially or completely removed from the corresponding one or more input audio signals. As mentioned above, the dereverberation may involve one or more generative networks (e.g., GANs), as further described with respect to FIGS. 1A and 1E. Thus, the enhanced mono audio signal may be a mono speech signal with dereverberation by application of one or more speech generative networks.

In some examples, the enhanced mono audio signal may be a source separated signal (e.g., a target signal from a particular audio source captured by one or more microphones or decoded from encoded audio data), wherein unwanted audio signals have been partially or completely removed from the corresponding one or more input audio signals. As mentioned above, the source separation may involve one or more generative networks (e.g., GANs), as further described with respect to FIGS. 1A and 1F. Thus, the enhanced mono audio signal may be a mono speech signal with source separated audio by application of one or more speech generative networks.

In some examples, the enhanced mono audio signal may be a bass adjusted signal (e.g., a music signal captured by one or more microphones or decoded from encoded audio data), wherein bass has been increased or reduced from the corresponding one or more input audio signals. As mentioned above, the bass adjustment may involve one or more generative networks (e.g., GANs), as further described with respect to FIGS. 1A and 1G. Thus, the enhanced mono audio signal may be a mono speech signal with bass adjusted by application of one or more speech generative networks.

In some examples, the enhanced mono audio signal may be an equalized signal (e.g., a music signal captured by one or more microphones or decoded from encoded audio data), wherein balance of different frequency components is adjusted from the corresponding one or more input audio signals. As mentioned above, the equalization may involve one or more generative networks (e.g., GANs), as further described with respect to FIGS. 1A and 1H. Thus, the enhanced mono audio signal may be a mono speech signal with equalization by application of one or more speech generative networks.

Systems and methods of audio signal enhancement are disclosed. In an illustrative example, a signal enhancer performs signal enhancement of an input audio signal to generate an enhanced mono audio signal. As described above, the enhanced mono audio signal may be an enhanced speech signal. The enhanced speech signal may be associated with a single/particular speaker. The enhanced speech signal may be a mono audio signal generated from one or more input audio signals. The one or more input audio signals may be captured using one or more microphones as described in more detail below. The enhanced mono audio signal is a single-channel audio signal.

As mentioned above, the signal enhancement can include at least one of noise suppression, audio zoom, beamforming, dereverberation, source separation, bass adjustment, or equalization. Audio context in the present disclosure may refer to ancillary or secondary audio signals and/or signal components, wherein the enhanced mono audio signal represents the primary audio signal or signal component, such as a speech signal associated with an individual/particular speaker. As described above, the enhanced mono audio signal may be a processed input audio signal, e.g., filtered or beamformed, or a synthetic audio signal, e.g., generated using generative networks based on the input audio signal. In some examples, the primary audio signal or signal component refers to an audio signal, such as a speech signal, from a specific audio source, such as an individual/particular speaker, received on a direct path from the audio source to one or more microphones (e.g., without reverberations or environmental noise). The audio context on the other hand may refer to audio signals and/or signal components other than the directly received audio signal from the particular audio source. In some examples, the audio context may include reverberated/reflected speech signals originating from the individual/particular speaker, speech signals from speakers other than the particular speaker, diffuse background noise, locally emanating or directional noise (e.g., from a moving vehicle), or combinations thereof.

An audio mixer generates a first audio signal that is based on the enhanced mono audio signal. In some examples, the first audio signal is the same as the enhanced mono audio signal. In other examples, the audio mixer can perform additional processing, such as panning or binauralization, on the enhanced mono audio signal to generate the first audio signal. In some aspects, the first audio signal corresponds to an enhanced audio signal with reduced audio context. To add such context, the audio mixer generates a second audio signal based on at least one of a directional audio signal, a background audio signal, or a reverberation signal. The audio mixer mixes the first audio signal and the second audio signal to generate a stereo audio signal. The stereo audio signal thus balances the signal enhancement included in the first audio signal with the audio context included in the second audio signal.

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1A depicts a device 102 including one or more processors (“processor(s)” 190 of FIG. 1A), which indicates that in some implementations the device 102 includes a single processor 190 and in other implementations the device 102 includes multiple processors 190. For ease of reference herein, such features are generally introduced as “one or more” features and are subsequently referred to in the singular unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein, e.g., when no particular one of the features is being referenced, the reference number is used without a distinguishing letter. However, when one particular feature of multiple features of the same type is referred to herein, the reference number is used with the distinguishing letter. For example, referring to FIG. 1A, multiple directional (direct.) audio signals are illustrated and associated with reference numbers 165A and 165B. When referring to a particular one of these directional audio signals, such as a directional audio signal 165A, the distinguishing letter “A” is used. However, when referring to any arbitrary one of these directional audio signals or to these directional audio signals as a group, the reference number 165 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element. As used herein, A “and/or” B may mean that either “A and B”, or “A or B”, or both “A and B” and “A or B” are applicable or acceptable.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1A, a particular illustrative aspect of a system configured to perform audio signal enhancement is disclosed and generally designated 100. The system 100 includes a device 102 that includes one or more processors 190. In some implementations, the device 102 is coupled to one or more microphones 120, one or more cameras 130, or a combination thereof. The one or more microphones 120 may include a one-dimensional or two-dimensional microphone array for performing beamforming. The one or more processors 190 include an audio analyzer 140 configured to process one or more input audio signals 125 to generate one or more stereo audio signals 149, as described herein.

The audio analyzer 140 is configured to obtain the one or more input audio signals 125 that represent a soundscape with sounds 185 of one or more audio sources 184. In some implementations, the one or more input audio signals 125 correspond to microphone output of the one or more microphones 120, decoded audio data, an audio stream, or a combination thereof. For example, the audio analyzer 140 is configured to receive a first input audio signal 125 from a first microphone of the one or more microphones 120, and to receive a second input audio signal 125 from a second microphone of the one or more microphones 120. In another example, the first input audio signal 125 corresponds to a first audio channel of the decoded audio data (or the audio stream), and the second input audio signal 125 corresponds to a second audio channel of the decoded audio data (or the audio stream).

In a particular aspect, the audio analyzer 140 is configured to obtain image data 127 that represents a visual scene associated with (e.g., including) the one or more audio sources 184. In some examples, the image data 127 is based on camera output, decoded image data, stored image data, a graphic visual stream, or a combination thereof.

The audio analyzer 140 includes a signal enhancer 142 coupled to an audio mixer 148. The audio analyzer 140 also includes a directional analyzer 144 coupled to the signal enhancer 142, the audio mixer 148, or both. In some implementations, the audio analyzer 140 includes a context analyzer 146 coupled to the directional analyzer 144, the audio mixer 148, or both. In some implementations, the audio analyzer 140 includes a location sensor 162 coupled to the context analyzer 146.

The context analyzer 146 is configured to process the image data 127 to generate a visual context 147 of the one or more input audio signals 125. The visual context 147 may include any information that is associated with the one or more input audio signals 125 except for the input audio signals 125 themselves and which can be derived based on the image data 127. Such information may include but is not limited to (relative) location(s) of audio source(s) in the visual scene, (relative) location(s) of microphone(s) in the visual scene, acoustic characteristics of the soundscape, such as open space, confined/closed space, room geometry, etc., or the like. In some examples, the visual context 147 indicates a location (e.g., an elevation and azimuth) of an audio source 184A (e.g., a person) of the one or more audio sources 184 in a visual scene represented by the image data 127. In some examples, the visual context 147 indicates an environment of the visual scene represented by the image data 127. For example, the visual context 147 is based on surfaces of an acoustic environment, room geometry, or both. In some implementations, the context analyzer 146 is configured to use a neural network 156 to process at least the image data 127 to generate the visual context 147. In some examples, one or more operations described herein as performed by a neutral network may be performed using a machine learned network, such as an artificial neural network (ANN), other types of machine learned networks (e.g., based on fuzzy logic, evolutionary programming, and/or genetic algorithms), etc.

The context analyzer 146 is configured to obtain location data 163 indicating a location of a soundscape represented by the one or more input audio signals 125, a visual scene represented by the image data 127, or both. In some implementations, the location sensor 162 (e.g., a global positioning system (GPS) sensor) is configured to generate the location data 163. In other implementations, the location data 163 is generated by an application, received from another device, or both.

The context analyzer 146 is configured to process the location data 163 to generate a location context 137 of the one or more input audio signals 125. For example, the location context 137 indicates a location, a location type, or both, of a soundscape represented by the one or more input audio signals 125, a visual scene represented by the image data 127, or both. In some implementations, the context analyzer 146 uses the neural network 156 to process at least the location data 163 to generate the location context 137.

The directional analyzer 144 is configured to perform directional audio coding (DirAC) on the one or more input audio signals 125 to generate one or more directional audio signals 165, a background audio signal 167, or both. The one or more directional audio signals 165 correspond to directional sounds (e.g., speech or car) and the background audio signal 167 corresponds to diffuse noise (e.g., wind noise or background traffic) in the soundscape. In some implementations, the directional analyzer 144 is configured to use a neural network 154 to perform the DirAC on the one or more input audio signals 125.

The signal enhancer 142 is configured to perform signal enhancement to generate one or more enhanced mono audio signals 143. The signal enhancement is performed on the one or more input audio signals 125, the one or more directional audio signals 165, or a combination thereof, to generate the one or more enhanced mono audio signals 143. For example, the signal enhancer 142 performs signal enhancement on a first input audio signal 125 to generate a first enhanced mono audio signal 143, and performs signal enhancement on a second input audio signal 125 to generate a second enhanced mono audio signal 143. As another example, the signal enhancer 142 performs signal enhancement on a directional audio signal 165A to generate a first enhanced mono audio signal 143, and performs signal enhancement on a directional audio signal 165B to generate a second enhanced mono audio signal 143. The signal enhancement includes at least one of noise suppression, audio zoom, beamforming, dereverberation, source separation, bass adjustment, or equalization. In a particular implementation, the signal enhancer 142 is configured to use a neural network 152 to perform the signal enhancement. For example, the signal enhancer 142 may be configured to use the neural network 152 (e.g., a GAN) to perform generative audio techniques to generate the one or more enhanced mono audio signals 143. To illustrate, the signal enhancer 142 may use the neural network 152 to partially or completely remove noise for noise suppression, to adjust signal gains for audio zoom, to perform beamforming for audio focus, to perform dereverberation for removing the effects of reverberation, to partially or fully separate audio for source separation, to perform bass adjustment for increasing or decreasing bass, to perform equalization for adjusting a balance of different frequency components, or a combination thereof.

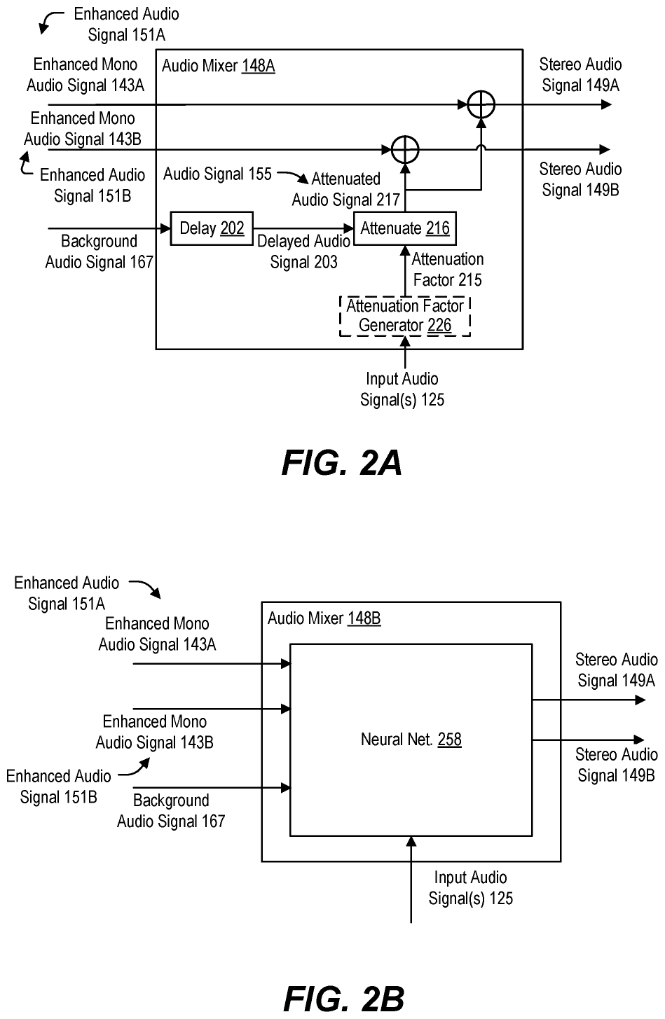

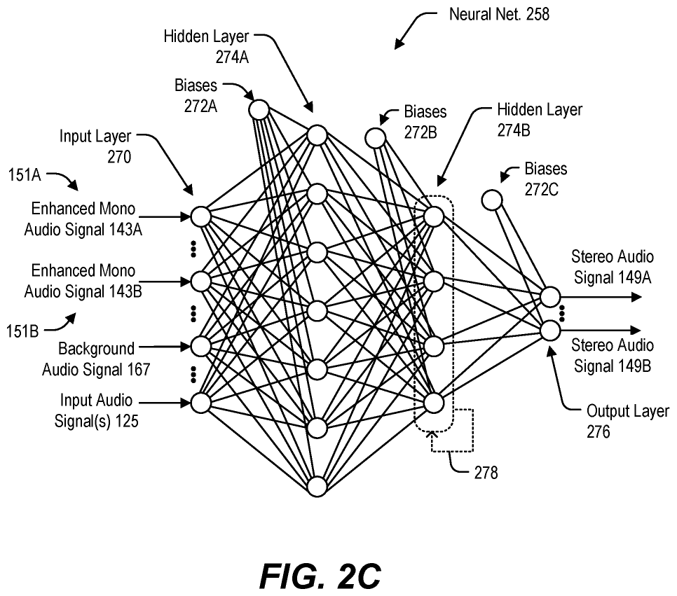

The audio mixer 148 is configured to generate one or more enhanced audio signals 151 based on the one or more enhanced mono audio signals 143, and to generate one or more audio signals 155 based on the one or more directional audio signals 165, the background audio signal 167, the location context 137, the visual context 147, or a combination thereof, as further described with reference to FIGS. 2A, 3A, 4A, 5A, and 6A. The audio mixer 148 is configured to mix the one or more enhanced audio signals 151 and the one or more audio signals 155 to generate one or more stereo audio signals 149, as further described with reference to FIGS. 2A, 3A, 4A, 5A, and 6A. In some implementations, the audio mixer 148 is configured to use a neural network to generate the one or more stereo audio signals 149, as further described with reference to FIGS. 2B, 2C, 3B, 3C, 4B, 4C, 5B, 5C, 6B, and 6C. The one or more stereo audio signals 149 include the signal enhancements of the one or more enhanced audio signals 151 and the audio context of the one or more audio signals 155.

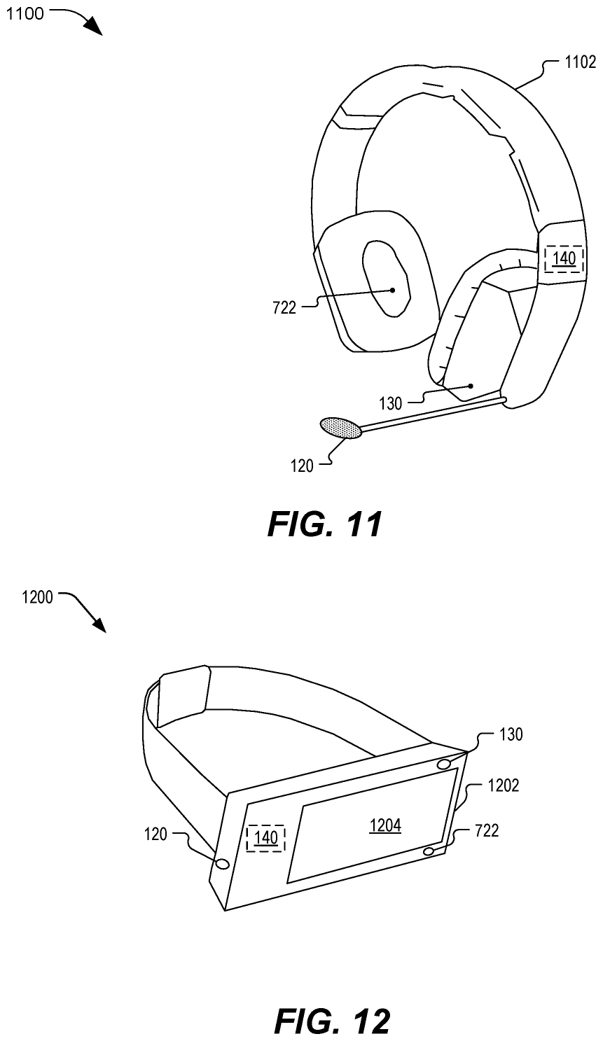

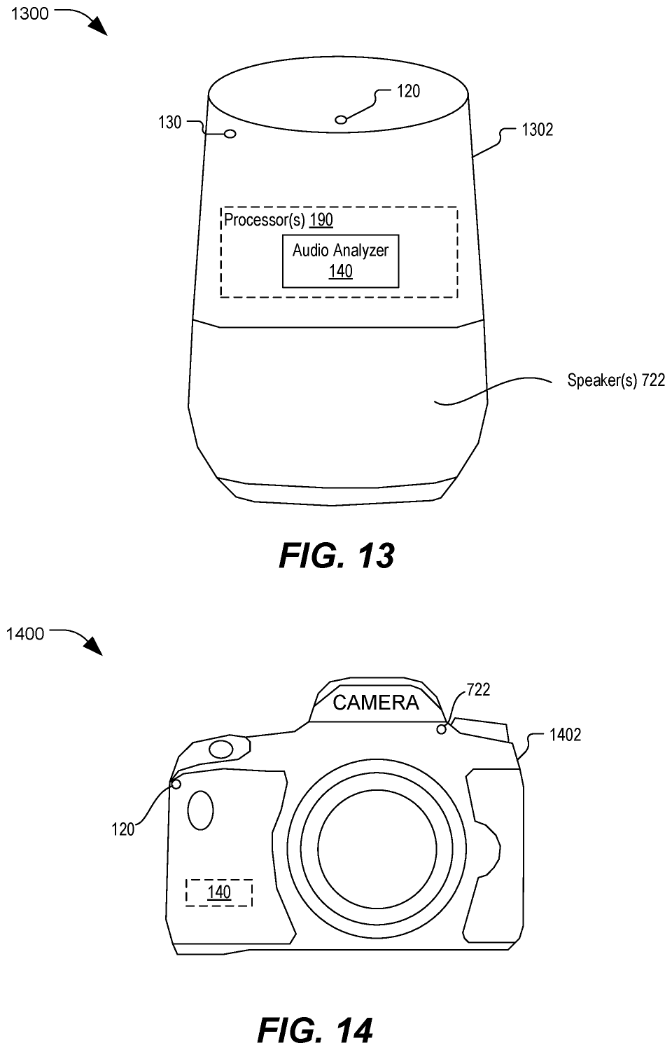

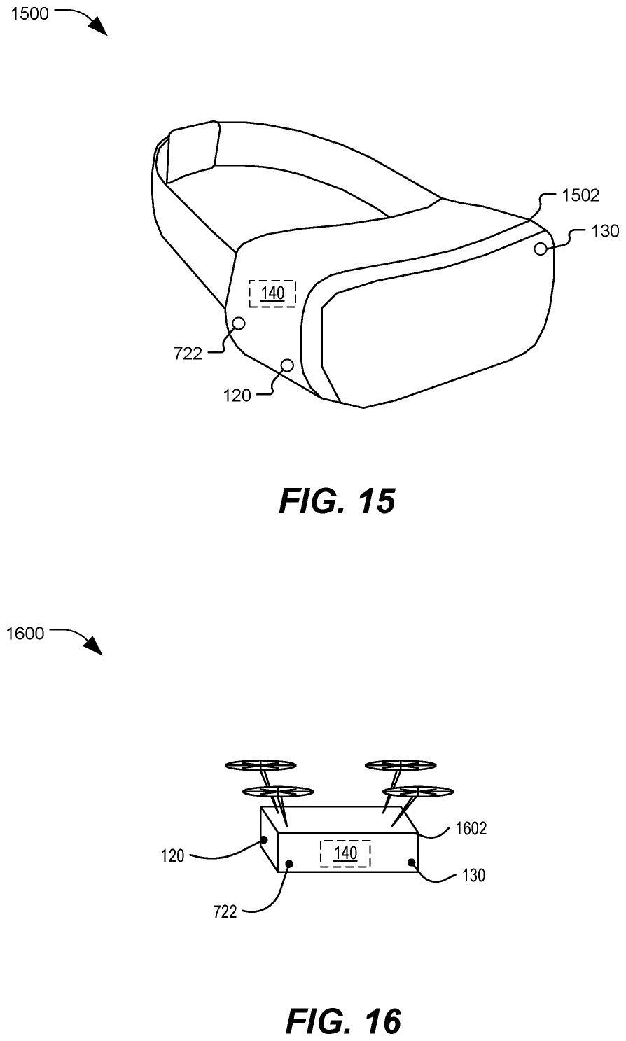

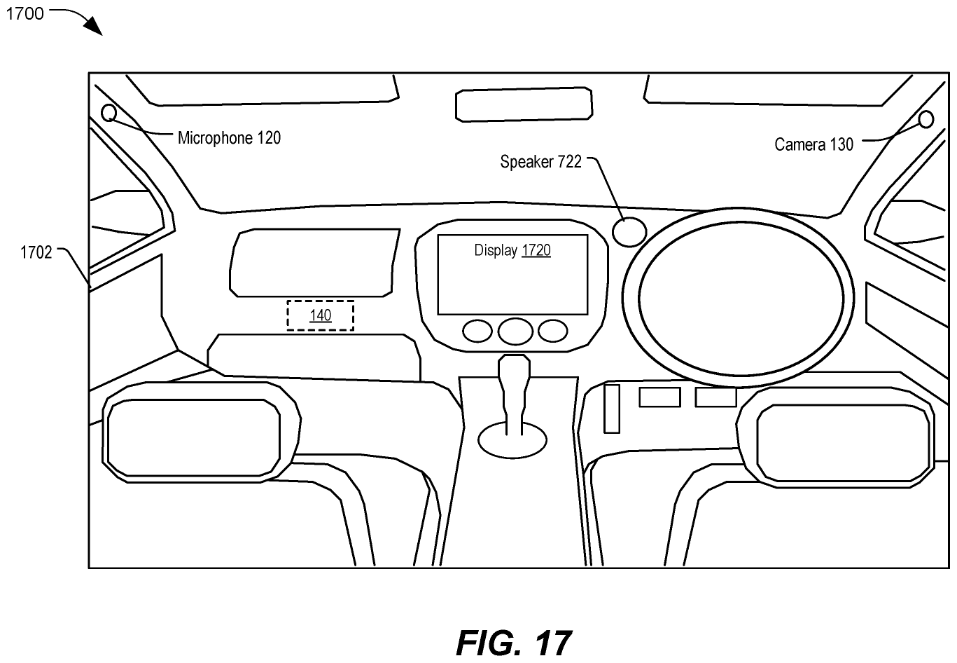

In some implementations, the device 102 corresponds to or is included in one of various types of devices. In an illustrative example, the one or more processors 190 are integrated in a headset device, such as described further with reference to FIG. 11. In other examples, the one or more processors 190 are integrated in at least one of a mobile phone or a tablet computer device, as described with reference to FIG. 10, a wearable electronic device, as described with reference to FIG. 12, a voice-controlled speaker system, as described with reference to FIG. 13, a camera device, as described with reference to FIG. 14, or a virtual reality, mixed reality, or augmented reality headset, as described with reference to FIG. 15. In another illustrative example, the one or more processors 190 are integrated into a vehicle, such as described further with reference to FIG. 16 and FIG. 17.

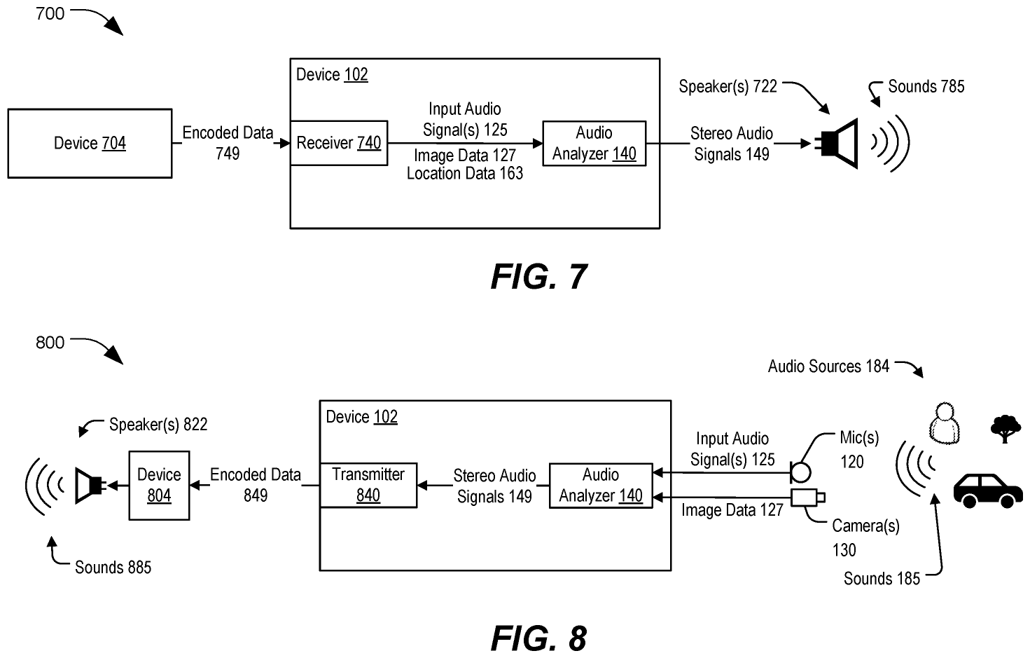

During operation, the audio analyzer 140 obtains one or more input audio signals 125. In an example, the one or more input audio signals 125 correspond to the sounds 185 of the one or more audio sources 184 captured by the one or more microphones 120. In another example, the one or more processors 190 are configured to decode encoded audio data to generate the one or more input audio signals 125, as further described with reference to FIG. 7. In an illustrative example, the encoded audio data corresponds to audio received during a call with a second user of a second device, and the audio analyzer 140 provides the one or more stereo audio signals 149 to one or more speakers for playback to the user 101, as further described with reference to FIG. 7. In some examples, the one or more input audio signals 125 are based on an audio stream. To illustrate, the one or more input audio signals 125 are generated by at least one of an audio player, a gaming application, a communication application, a video player, an augmented reality application, or another application of the one or more processors 190.

In an example, the one or more audio sources 184 include an audio source 184A, an audio source 184B, an audio source 184C, one or more additional audio sources, or a combination thereof. To illustrate, the sounds 185 include speech from the audio source 184A (e.g., a person), directional noise from the audio source 184B (e.g., a car driving by), diffuse noise from the audio source 184C (e.g., leaves moving in the wind), or a combination thereof. In some examples, the audio source 184C can be invisible, such as wind. In some examples, the audio source 184C can correspond to multiple audio sources, such as traffic or leaves, that together correspond to diffuse noise. In some examples, sound from the audio source 184C can be directionless or all around.

In a particular aspect, the audio analyzer 140 obtains image data 127 representing a visual scene associated with (e.g., including) the one or more audio sources 184. In an example, the audio analyzer 140 is configured to receive the image data 127 from the one or more cameras 130 concurrently with receiving the one or more input audio signals 125 from the one or more microphones 120. In another example, the one or more processors 190 are configured to receive encoded data from another device and to decode the encoded data to generate the image data 127, as further described with reference to FIG. 7. In some implementations, the image data 127 is based on a graphic visual stream received from an application of the one or more processors 190, such as the same application that generated the one or more input audio signals 125.

In some implementations, the context analyzer 146 determines, based on the image data 127, a visual context 147 of the one or more input audio signals 125. In an illustrative example, the context analyzer 146 performs audio source detection (e.g., face detection) on the image data 127 to generate the visual context 147 indicating a location (e.g., an elevation and azimuth) of the audio source 184A (e.g., a person) of the one or more audio sources 184 in a visual scene represented by the image data 127. In a particular aspect, the visual context 147 indicates the location of the audio source 184A relative to a location of a notional listener, e.g., represented by the one or more microphones 120, in the visual scene.

In a particular aspect, the visual context 147 is based on a user input 103 indicating a position (e.g., location, orientation, tilt, or a combination thereof) of the user 101 (e.g., the head of the user 101). To illustrate, the user input 103 can correspond to sensor data indicating movement of a headset, camera output representing an image of the user 101, or both. In some implementations, the visual context 147 indicates an environment of the visual scene represented by the image data 127. For example, the visual context 147 is based on surfaces of an environment, room geometry, or both.

In some implementations, the context analyzer 146 obtains location data 163 indicating a location of a soundscape represented by the one or more input audio signals 125, a visual scene represented by the image data 127, or both. In some implementations, the context analyzer 146 processes the image data 127 based on the location data 163 to determine the visual context 147. In an illustrative example, the context analyzer 146 processes the image data 127 and detects multiple faces. The context analyzer 146, in response to determining that the location data 163 indicates an art gallery, performs an analysis of the image data 127 to distinguish between a painted face and an actual person to generate the visual context 147 indicating a location of the person as the audio source 184A.

In some aspects, the audio analyzer 140 determines, based on the location data 163, a location context 137 of the one or more input audio signals 125. The location context 137 indicates a particular location indicated by the location data 163, a location type of the particular location, or both. The location indicated by the location data 163 can correspond to a geographical location, a virtual location, or both. The location type can indicate an open space or a closed or confined space. Non-limiting examples of the location type may be indoors, outdoors, office, playground, park, aircraft interior, vehicle interior, etc.

In some examples, the location data 163 corresponds to GPS data indicating a location of the device 102, the one or more microphones 120, another device used to generate the one or more input audio signals 125, or a combination thereof. The context analyzer 146 generates the location context 137 indicating the location, location type, or both, associated with the GPS data. As another example, an application (e.g., a gaming application) of the one or more processors 190 generates the location data 163 indicating a virtual location of the soundscape represented by the one or more input audio signals 125. The context analyzer 146 generates the location context 137 indicating the virtual location (e.g., “training hall”), a type of the virtual location (e.g., “large room”), or both.

In some implementations, the location data 163 corresponds to user data (e.g., calendar data, user login data, etc.) indicating that a user 101 of the device 102 is at a particular location when the one or more input audio signals 125 are generated by the one or more microphones 120 of the device 102. In a particular aspect, the location data 163 corresponds to user data (e.g., calendar data, user login data, etc.) indicating that a second user (e.g., the audio source 184A) is at a particular location when the one or more input audio signals 125 are received from a second device of the second user. The context analyzer 146 generates the location context 137 indicating the particular location (e.g., Grand Bazaar), type of the particular location (e.g., covered market), or both.

In some examples, the context analyzer 146 processes the location data 163 based on an image analysis of the image data 127, an audio analysis of the one or more input audio signals 125, or both, to generate the location context 137. As an illustrative example, the context analyzer 146, in response to determining that the location data 163 indicates a highway and the image data 127 indicates an interior of a vehicle, generates the location context 137 indicating a location type corresponding to a vehicle interior on a highway.

The directional analyzer 144 performs DirAC on the one or more input audio signals 125 to generate one or more directional audio signals 165, a background audio signal 167, or both. In some aspects, the one or more directional audio signals 165 correspond to directional sounds and the background audio signal 167 corresponds to diffuse noise. In an illustrative example, a directional audio signal 165A represents the speech from an audio source 184A (e.g., a person), a directional audio signal 165B represents directional noise from an audio source 184B (e.g., a car driving by), and the background audio signal 167 represents diffuse noise from an audio source 184C (e.g., leaves moving in the wind). In some aspects, a particular sound direction of the sounds represented by the directional audio signal 165A can change over time. In an illustrative example, the direction of the sounds represented by the directional audio signal 165A changes as the audio source 184B (e.g., the car) moves relative to a notional listener in a soundscape represented by the one or more input audio signals 125.

In some implementations, the directional analyzer 144 generates the directional audio signal 165A based on audio source detection data (e.g., face detection data) indicated by the visual context 147. For example, the visual context 147 indicates an estimated location (e.g., absolute location or relative location) of the audio source 184A in a visual scene represented by the image data 127 and the directional analyzer 144 generates the directional audio signal 165A based on sounds corresponding to the estimated location. As another example, the directional analyzer 144, in response to determining that the visual context 147 indicates a particular audio source type (e.g., a face), performs analysis corresponding to the particular audio source type (e.g., speech separation) to generate the directional audio signal 165A from the one or more input audio signals 125. As another example, the directional analyzer 144, in response to determining a (relative) location of an audio source, e.g., audio source 184A, performs spatial filtering or beamforming of a plurality of input audio signals captured by a plurality of microphones 120 to spatially isolate an audio signal from the audio source. In a particular example, the directional analyzer 144, in response to determining a (relative) location of an audio source, e.g., audio source 184A, performs gain adjustment of a plurality of input audio signals captured by a plurality of microphones 120 to perform an audio zoom of an audio signal from the audio source.

In some implementations, the directional analyzer 144 provides the one or more directional audio signals 165 to the signal enhancer 142 and the background audio signal 167 to the audio mixer 148. In these implementations, the signal enhancer 142 performs signal enhancement of the one or more directional audio signals 165 to generate the one or more enhanced mono audio signals 143. The audio mixer 148 generates the one or more stereo audio signals 149 based on the one or more enhanced mono audio signals 143 and the background audio signal 167.

In some implementations, the directional analyzer 144 provides the one or more directional audio signals 165, the background audio signal 167, or a combination thereof, to the audio mixer 148. In these implementations, the signal enhancer 142 performs signal enhancement of the one or more input audio signals 125 to generate the one or more enhanced mono audio signals 143. The audio mixer 148 generates the one or more stereo audio signals 149 based on the one or more enhanced mono audio signals 143 and further based on the one or more directional audio signals 165, the background audio signal 167, or a combination thereof.

The signal enhancer 142 performs signal enhancement to generate the one or more enhanced mono audio signals 143. The signal enhancement includes at least one of noise suppression, audio zoom, beamforming, dereverberation, source separation, bass adjustment, or equalization. In some examples, the signal enhancer 142 selects the signal enhancement from at least one of noise suppression, audio zoom, beamforming, dereverberation, source separation, bass adjustment, or equalization, and performs the selected signal enhancement to generate the one or more enhanced mono audio signals 143. The signal enhancer 142 can select the signal enhancement based on a user input 103 received from the user 101, a configuration setting, default data, or a combination thereof.

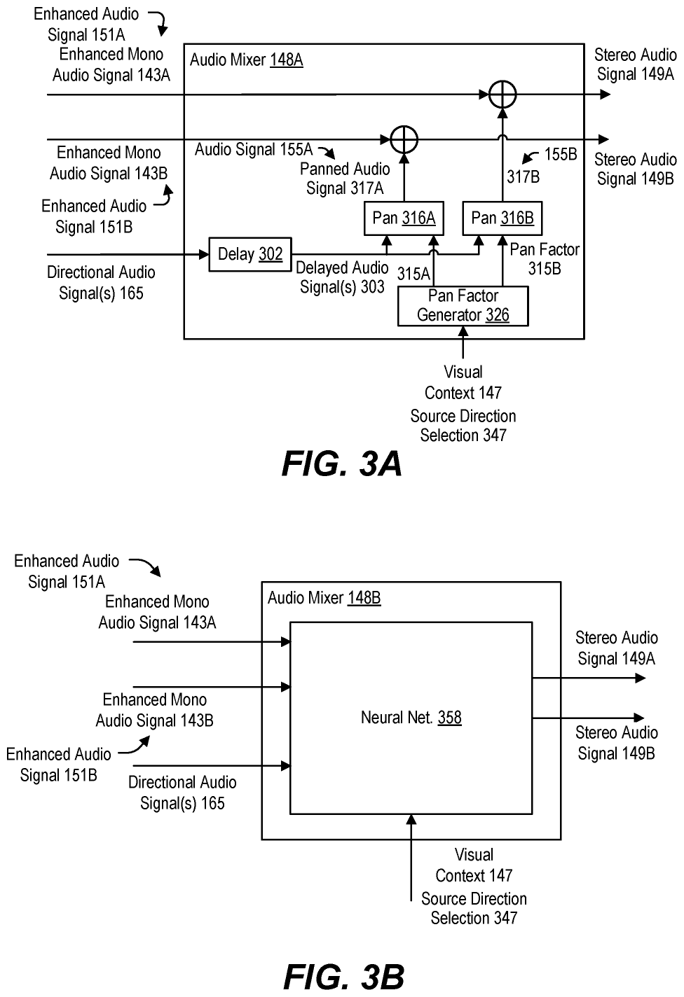

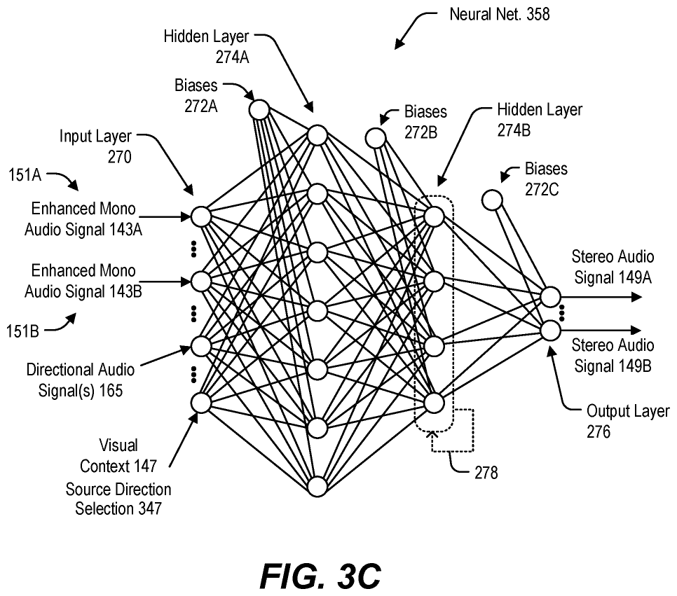

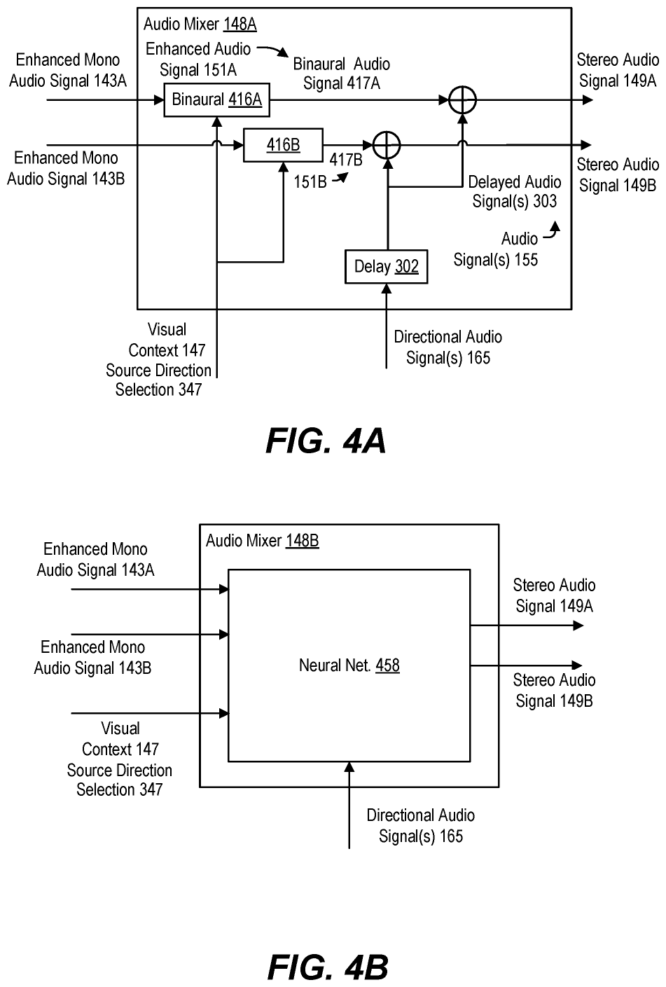

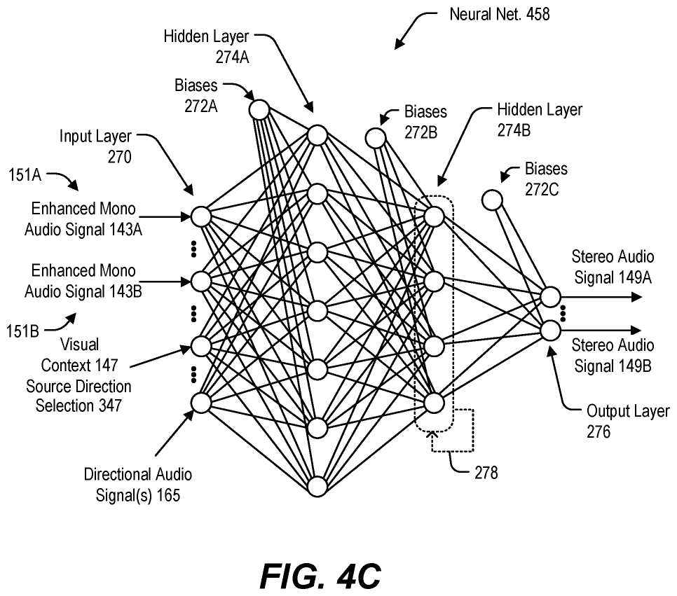

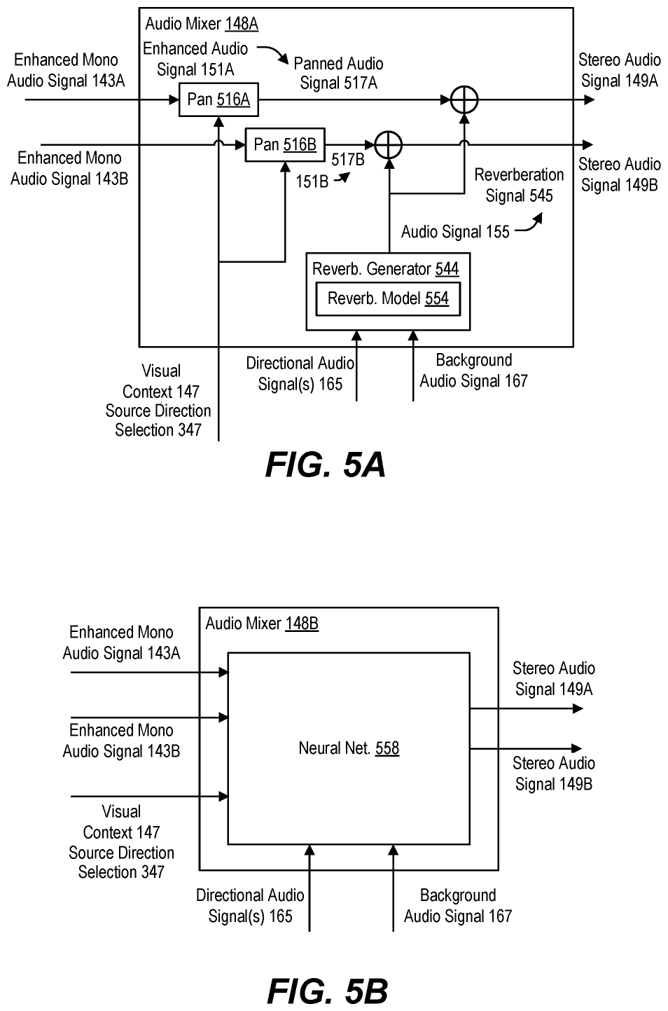

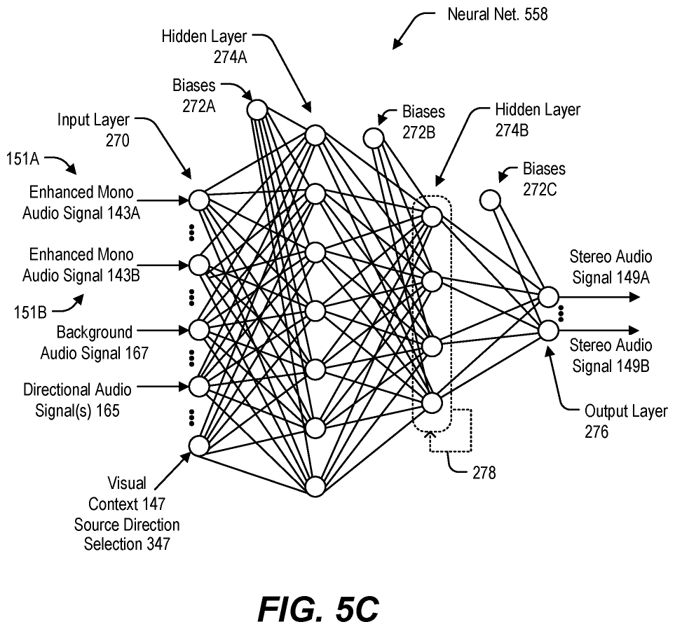

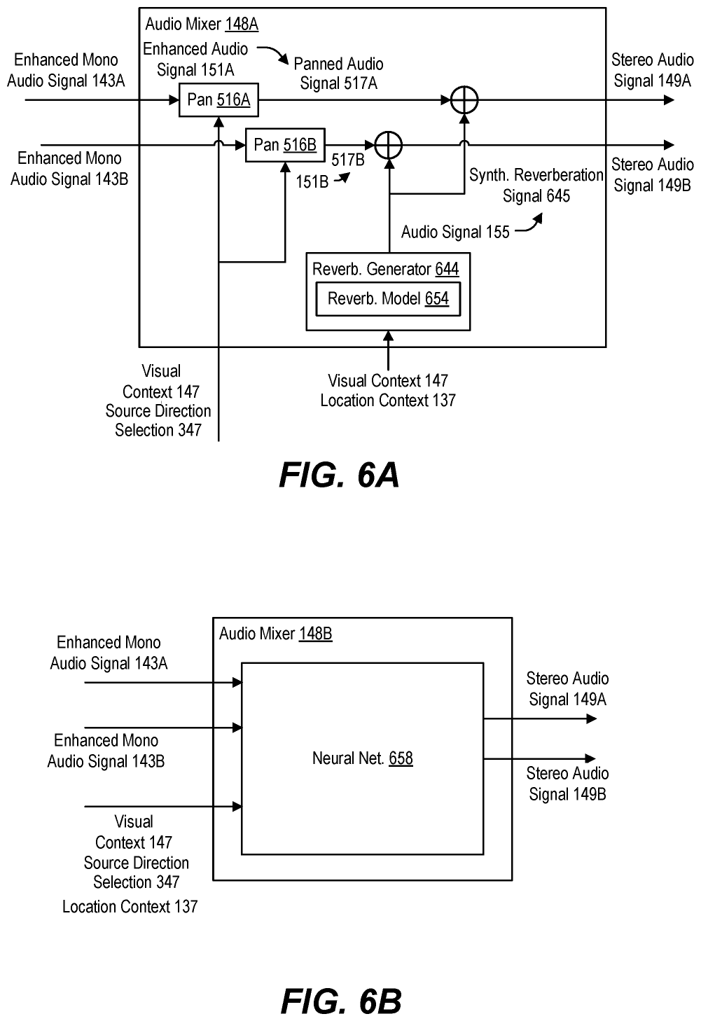

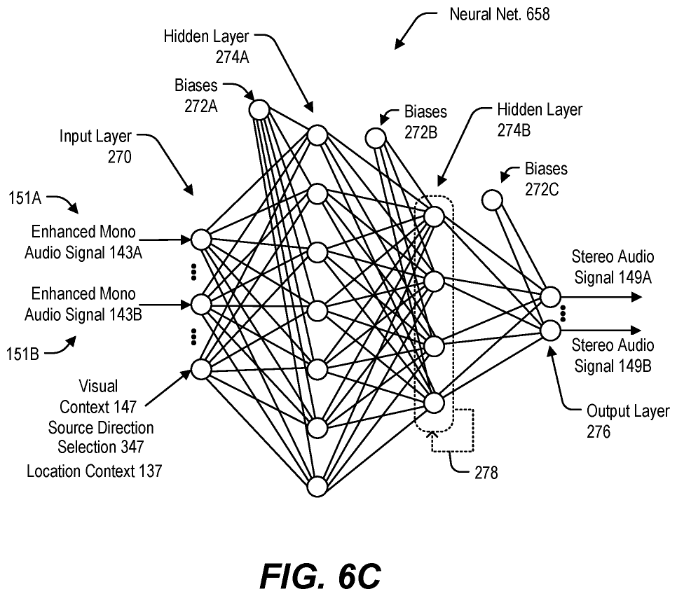

The audio mixer 148 receives the one or more enhanced mono audio signals 143 from the signal enhancer 142. The audio mixer 148 also receives at least one of the one or more directional audio signals 165, the background audio signal 167, the location context 137, the visual context 147, or a combination thereof. The audio mixer 148 generates one or more enhanced audio signals 151 based on the one or more enhanced mono audio signals 143, and generates one or more audio signals 155 based on the one or more directional audio signals 165, the background audio signal 167, the visual context 147, or a combination thereof. In some implementations, the one or more enhanced audio signals 151 are the same as the one or more enhanced mono audio signals 143, as further described with reference to FIGS. 2A and 3A. In some implementations, the one or more enhanced audio signals 151 correspond to binauralization applied to the one or more enhanced mono audio signals 143, as further described with reference to FIG. 4A. In some implementations, the one or more enhanced audio signals 151 correspond to panning applied to the one or more enhanced mono audio signals 143, as further described with reference to FIGS. 5A and 6A. The one or more enhanced audio signals 151 are based on the one or more enhanced mono audio signals 143 and include the signal enhancements performed by the signal enhancer 142.

In some implementations, the one or more audio signals 155 correspond to delay and attenuation applied to the background audio signal 167, as further described with reference to FIG. 2A. In some implementations, the one or more audio signals 155 correspond to delay and panning applied to the one or more directional audio signals 165, as further described with reference to FIG. 3A. In some implementations, the one or more audio signals 155 correspond to delay applied to the one or more directional audio signals 165, as further described with reference to FIG. 4A. In some implementations, the one or more audio signals 155 correspond to a reverberation signal that is based on the one or more directional audio signals 165, the background audio signal 167, or a combination thereof, as further described with reference to FIG. 5A. In some implementations, the one or more audio signals 155 correspond to a synthesized reverberation signal that is based on the location context 137, the visual context 147, or both, as further described with reference to FIG. 6A. The one or more audio signals 155 include audio context associated with the one or more input audio signals 125.

The audio mixer 148 mixes the one or more enhanced audio signals 151 and the one or more audio signals 155 to generate one or more stereo audio signals 149. In a particular implementation, the audio mixer 148 receives an enhanced mono audio signal 143A (e.g., enhanced first microphone sound, such as noise suppressed speech), an enhanced mono audio signal 143B (e.g., enhanced second microphone sound, such as noise suppressed speech), the directional audio signal 165A (e.g., the speech), the directional audio signal 165B (e.g., the directional noise), the background audio signal 167 (e.g., the diffuse noise), or a combination thereof. In an illustrative example of this implementation, the audio mixer 148 mixes the one or more enhanced audio signals 151 corresponding to the noise suppressed speech with the one or more audio signals 155 corresponding to the directional noise or corresponding to a reverberation signal that is based on the directional noise or diffuse noise. The one or more stereo audio signals 149 include less noise (e.g., no diffuse noise) than the one or more input audio signals 125 while providing more audio context (e.g., directional noise, reverberation based on background noise, etc.) than the one or more enhanced mono audio signals 143 (e.g., noise suppressed speech).

In an alternative implementation, the signal enhancer 142 performs signal enhancement on the directional audio signal 165A and the directional audio signal 165B to generate the enhanced mono audio signal 143A (e.g., enhanced speech) and the enhanced mono audio signal 143B (e.g., signal enhanced directional noise, such as noise suppressed silence), respectively. The audio mixer 148 receives the enhanced mono audio signal 143A (e.g., enhanced speech), the enhanced mono audio signal 143B (e.g., noise suppressed silence), and the background audio signal 167 (e.g., the diffuse noise). In an illustrative example of this implementation, the audio mixer 148 receives and mixes the one or more enhanced audio signals 151 corresponding to noise suppressed speech and silence with the one or more audio signals 155 corresponding to a reverberation signal that is based on the diffuse noise. The stereo audio signals 149 include less noise than the input audio signals 125 (e.g., no background noise) while providing more audio context (e.g., reverberation based on the diffuse noise) than the one or more enhanced mono audio signals 143 (e.g., noise suppressed speech).

The system 100 thus balances signal enhancement performed by the signal enhancer 142 and audio context associated with the one or more input audio signals 125 in generating the one or more stereo audio signals 149. For example, the one or more stereo audio signals 149 can include directional noise or reverberation that provides audio context to a listener while removing at least some of the background noise (e.g., diffuse noise or all background noise).

Optionally, in some implementations, the signal enhancer 142 selects one or more of the signal enhancements (e.g., noise suppression, the audio zoom, the beamforming, the dereverberation, the source separation, the bass adjustment, or the equalization), and a second signal enhancer performs one or more remaining ones of the signal enhancements. In a particular aspect, the second signal enhancer is a component that is external to the signal enhancer 142 (as the directional analyzer 144 is external to the signal enhancer 142). In these implementations, particular signal enhancement by the signal enhancer 142 can be performed before or after other signal enhancement by the second signal enhancer. To illustrate, an input of the signal enhancer 142 can be based on an output of the second signal enhancer, an input of the second signal enhancer can be based on an output of the signal enhancer 142, or both. For example, the second signal enhancer performs particular signal enhancement on the one or more input audio signals 125 or the directional audio signals 165 to generate one or more second enhanced mono audio signals, and the signal enhancer 142 performs other signal enhancement on the one or more second enhanced mono audio signals to generate the one or more enhanced mono audio signals 143. In another example, the second signal enhancer performs additional signal enhancement on the one or more enhanced mono audio signals 143 to generate one or more second enhanced mono audio signals, and the audio mixer 148 generates the one or more enhanced audio signals 151 based on the one or more second enhanced mono audio signals.

Although the one or more microphones 120 and the one or more cameras 130 are shown as external to the device 102, in other implementations at least one of the one or more microphones 120 or the one or more cameras 130 can be integrated in the device 102. Although the one or more input audio signals 125 are illustrated as corresponding to microphone output of the one or more microphones 120, in other implementations the one or more input audio signals 125 can correspond to decoded audio data, an audio stream, stored audio data, or a combination thereof. Although the image data 127 is illustrated as corresponding to camera output of the one or more cameras 130, in other implementations the image data 127 can correspond to decoded image data, an image stream, stored image data, or a combination thereof.

Although the audio analyzer 140 is illustrated as included in a single device (e.g., 140), two or more components of the audio analyzer 140 can be distributed across multiple devices. For example, the signal enhancer 142, the directional analyzer 144, the context analyzer 146, the location sensor 162, or a combination thereof can be integrated in a first device (e.g., a user playback device) and the audio mixer 148 can be integrated in a second device (e.g., a headset).

Optionally, one or more operations described herein with reference to components of the audio analyzer 140 can be performed by neural networks. In one such example, the signal enhancer 142 uses the neural network 152 (e.g., a speech generative network) to perform signal enhancement to generate the enhanced mono audio signal 143A representing an enhanced version of the speech of the audio source 184A. In another example, the directional analyzer 144 uses the neural network 154 to process the one or more input audio signals 125 to generate the one or more directional audio signals 165, the background audio signal 167, or a combination thereof. In yet another example, the context analyzer 146 uses the neural network 156 to process the image data 127, the location data 163, or both, to generate the visual context 147, the location context 137, or both. In some examples, the neural network 156 includes a first neural network and a second neural network to process the image data 127, the location data 163, or both, to generate the visual context 147 and the location context 137, respectively. In an example, the audio mixer 148 uses a neural network to generate the one or more stereo audio signals 149, as further described with reference to FIGS. 2B, 3B, 4B, 5B, 6B and with reference to FIGS. 2C, 3C, 4C, 5C, 6C. In some implementations, two or more of the neural networks described herein can be combined into a single neural network.

Referring to FIG. 1B, an illustrative implementation of the signal enhancer 142 is shown. The signal enhancer 142 is configured to perform noise suppression 132 on one or more input audio signals 115A to generate one or more enhanced audio signals 133A.

The signal enhancer 142 performs the noise suppression 132 to, partially or completely, remove noise from the one or more input audio signals 115A to generate the one or more enhanced audio signals 133A (e.g., enhanced mono audio signal(s)). The one or more input audio signals 115A are based on the one or more input audio signals 125 or the one or more directional audio signals 165. For example, the one or more input audio signal 115A are the one or more input audio signals 125. As another example, the one or more input audio signal 115A are the one or more directional audio signals 165. In yet another example, the one or more input audio signals 115A include one or more enhanced audio signals generated by the signal enhancer 142, as described with reference to FIGS. 1C-1H. In a particular example, the one or more input audio signals 115A include one or more enhanced audio signals generated by a second signal enhancer that is external to the signal enhancer 142.

In an example, the one or more enhanced audio signals 133A correspond to one or more noise suppressed speech signals. Optionally, in some implementations, the signal enhancer 142 uses a neural network 152A to perform the noise suppression 132. Thus, the one or more enhanced audio signals 133A may be one or more mono speech signals with noise suppressed by application of the neural network 152A. The one or more enhanced mono audio signals 143 are based on the one or more enhanced audio signals 133A.

Referring to FIG. 1C, an illustrative implementation of the signal enhancer 142 is shown. The signal enhancer 142 is configured to perform audio zoom 134 on input audio signals 115B to generate enhanced audio signals 133B.

The signal enhancer 142 performs the audio zoom 134 to reduce the gain of an unwanted audio signal of the input audio signals 115B, increase the gain of a target audio signal of the input audio signals 115B, or both, to generate the enhanced audio signals 133B (e.g., enhanced mono audio signals). The enhanced audio signals 133B correspond to audio zoomed signals. The input audio signals 115B are based on the input audio signals 125 or the directional audio signals 165. For example, the input audio signals 115B are the input audio signals 125. As another example, the input audio signals 115B are the directional audio signals 165. In yet another example, the input audio signals 115B include enhanced audio signals generated by the signal enhancer 142, as described with reference to FIGS. 1B, 1D-1H. In a particular example, the input audio signals 115B include enhanced audio signals generated by a second signal enhancer that is external to the signal enhancer 142.

In an example, the enhanced audio signals 133B correspond to zoomed speech signals. Optionally, in some implementations, the signal enhancer 142 uses a neural network 152B to perform the audio zoom 134. Thus, the enhanced audio signals 133B may be mono speech signals with zoomed audio generated by application of the neural network 152B. The one or more enhanced mono audio signals 143 are based on the enhanced audio signals 133B.

Referring to FIG. 1D, an illustrative implementation of the signal enhancer 142 is shown. The signal enhancer 142 is configured to perform beamforming 136 on input audio signals 115C to generate enhanced audio signals 133C.

The signal enhancer 142 performs the beamforming 136 to form a virtual beam in the direction of a primary (e.g., target) audio source and/or a null beam in the direction of secondary (e.g., unwanted) audio sources to generate the enhanced audio signals 133C (e.g., enhanced mono audio signals). The enhanced audio signals 133C correspond to beamformed audio signals. The input audio signals 115C are based on the input audio signals 125 or the directional audio signals 165. For example, the input audio signals 115C are the input audio signals 125. As another example, the input audio signals 115B are the directional audio signals 165. In yet another example, the input audio signals 115C include enhanced audio signals generated by the signal enhancer 142, as described with reference to FIGS. 1A-1C, 1E-1H. In a particular example, the input audio signals 115B include one or more enhanced audio signals generated by a second signal enhancer that is external to the signal enhancer 142.

In an example, the enhanced audio signals 133C correspond to beamformed speech signals. Optionally, in some implementations, the signal enhancer 142 uses a neural network 152C to perform the beamforming 136. Thus, the enhanced audio signals 133B may be mono speech signals with beamformed audio generated by application of the neural network 152C. The one or more enhanced mono audio signals 143 are based on the enhanced audio signals 133B.

Referring to FIG. 1E, an illustrative implementation of the signal enhancer 142 is shown. The signal enhancer 142 is configured to perform dereverberation 138 on one or more input audio signals 115D to generate one or more enhanced audio signals 133D.

The signal enhancer 142 performs the dereverberation 138 to, partially or completely, remove reverberation from the one or more input audio signals 115D to generate the one or more enhanced audio signals 133D (e.g., enhanced mono audio signal(s)). The one or more input audio signals 115D are based on the one or more input audio signals 125 or the one or more directional audio signals 165. For example, the one or more input audio signals 115D are the one or more input audio signals 125. As another example, the one or more input audio signals 115D are the one or more directional audio signals 165. In yet another example, the one or more input audio signals 115D include one or more enhanced audio signals generated by the signal enhancer 142, as described with reference to FIGS. 1B-1D, 1F-1H. In a particular example, the one or more input audio signal 115D include one or more enhanced audio signals generated by a second signal enhancer that is external to the signal enhancer 142.

In an example, the one or more enhanced audio signals 133D correspond to one or more dereverberated speech signals. Optionally, in some implementations, the signal enhancer 142 uses a neural network 152D to perform the dereverberation 138. Thus, the one or more enhanced audio signals 133D may be one or more mono speech signals with dereverberation generated by application of the neural network 152D. The one or more enhanced mono audio signals 143 are based on the one or more enhanced audio signals 133D.

Referring to FIG. 1F, an illustrative implementation of the signal enhancer 142 is shown. The signal enhancer 142 is configured to perform source separation 150 on one or more input audio signals 115E to generate one or more enhanced audio signals 133E.

The signal enhancer 142 performs the source separation 150 to, partially or completely, remove sounds of secondary (e.g., unwanted) audio sources from the one or more input audio signals 115E to generate the one or more enhanced audio signals 133E (e.g., enhanced mono audio signal(s)). The one or more input audio signals 115E are based on the one or more input audio signals 125 or the one or more directional audio signals 165. For example, the one or more input audio signals 115E are the one or more input audio signals 125. As another example, the one or more input audio signals 115E are the one or more directional audio signals 165. In yet another example, the one or more input audio signals 115E include one or more enhanced audio signals generated by the signal enhancer 142, as described with reference to FIGS. 1B-1E, 1G-1H. In a particular example, the one or more input audio signals 115E include one or more enhanced audio signals generated by a second signal enhancer that is external to the signal enhancer 142.

In an example, the one or more enhanced audio signals 133E correspond to source separated speech signals. Optionally, in some implementations, the signal enhancer 142 uses a neural network 152E to perform the source separation 150. Thus, the one or more enhanced audio signals 133E may be one or more mono speech signals with source separated audio generated by application of the neural network 152E. The one or more enhanced mono audio signals 143 are based on the one or more enhanced audio signals 133E.

Referring to FIG. 1G, an illustrative implementation of the signal enhancer 142 is shown. The signal enhancer 142 is configured to perform bass adjustment 158 on one or more input audio signals 115F to generate one or more enhanced audio signals 133F.

The signal enhancer 142 performs the bass adjustment 158 to increase or decrease bass in the one or more input audio signals 115F to generate the one or more enhanced audio signals 133F (e.g., enhanced mono audio signal(s)). The one or more input audio signals 115F are based on the one or more input audio signals 125 or the one or more directional audio signals 165. For example, the one or more input audio signals 115F are the one or more input audio signals 125. As another example, the one or more input audio signals 115F are the one or more directional audio signals 165. In yet another example, the one or more input audio signals 115F include one or more enhanced audio signals generated by the signal enhancer 142, as described with reference to FIGS. 1B-1F, 1H. In a particular example, the one or more input audio signals 115F include one or more enhanced audio signals generated by a second signal enhancer that is external to the signal enhancer 142.

In an example, the one or more enhanced audio signals 133F correspond to one or more bass adjusted speech signals. Optionally, in some implementations, the signal enhancer 142 uses a neural network 152F to perform the bass adjustment 158. Thus, the one or more enhanced audio signals 133F may be one or more mono speech signals with bass adjusted by application of the neural network 152F. The one or more enhanced mono audio signals 143 are based on the one or more enhanced audio signals 133F.

Referring to FIG. 1H, an illustrative implementation of the signal enhancer 142 is shown. The signal enhancer 142 is configured to perform equalization 160 on one or more input audio signals 115G to generate one or more enhanced audio signals 133G.

The signal enhancer 142 performs the equalization 160 to adjust a balance of various frequency components of the one or more input audio signals 115G to generate the one or more enhanced audio signals 133G (e.g., an enhanced mono audio signal). The one or more input audio signals 115G are based on the one or more input audio signals 125 or the one or more directional audio signals 165. For example, the one or more input audio signals 115G are the one or more input audio signals 125. As another example, the one or more input audio signals 115G are the one or more directional audio signals 165. In yet another example, the one or more input audio signals 115G include one or more enhanced audio signals generated by the signal enhancer 142, as described with reference to FIGS. 1B-1G. In a particular example, the one or more input audio signals 115G include one or more enhanced audio signals generated by a second signal enhancer that is external to the signal enhancer 142.

In an example, the one or more enhanced audio signals 133G correspond to one or more equalized signals (e.g., music audio). Optionally, in some implementations, the signal enhancer 142 uses a neural network 152G to perform the equalization 160. Thus, the one or more enhanced audio signals 133G may be one or more mono speech signals with equalization performed by application of the neural network 152G. The one or more enhanced mono audio signals 143 are based on the one or more enhanced audio signals 133G.

FIGS. 2A-6C show aspects of various illustrative implementations of the audio mixer 148. FIGS. 2B, 3B, 4B, 5B, and 6B illustrate aspects of an audio mixer 148B that includes a neural network trained to generate one or more stereo audio signals 149 that are similar to one or more stereo audio signals 149 generated by an audio mixer 148A of the FIGS. 2A, 3A, 4A, 5A, and 6A, respectively. FIGS. 2C, 3C, 4C, 5C, and 6C illustrate examples of neural networks trained to generate one or more stereo audio signals 149 that are similar to one or more stereo audio signals 149 generated by an audio mixer 148A of the FIGS. 2A, 3A, 4A, 5A, and 6A, respectively.

Referring to FIG. 2A, a diagram of an illustrative aspect of an audio mixer 148A is shown. In a particular aspect, the audio mixer 148A corresponds to an implementation of the audio mixer 148 of FIG. 1A.

In the example illustrated in FIG. 2A, the one or more enhanced audio signals 151 are the same as the one or more enhanced mono audio signals 143. For example, an enhanced audio signal 151A corresponds to the enhanced mono audio signal 143A, an enhanced audio signal 151B corresponds to the enhanced mono audio signal 143B, and so on.

The audio mixer 148A generates an audio signal 155 based on the background audio signal 167. For example, the audio mixer 148A applies a delay 202 to the background audio signal 167 to generate a delayed audio signal 203. In some aspects, an amount of the delay 202 is based on the user input 103 of FIG. 1A, a configuration setting, a default delay, or a combination thereof.

Additionally or alternatively, the audio mixer 148A performs an attenuate operation 216 including applying an attenuation factor 215 to the (delayed) audio signal 203 to generate an attenuated audio signal 217. In some aspects, the attenuation factor 215 is based on the user input 103 of FIG. 1A, a configuration setting, a default value, or a combination thereof. In other aspects, an attenuation factor generator 226 of the audio mixer 148A determines the attenuation factor 215 based on an audio context indicated by or derived from the one or more input audio signals 125. For example, the attenuation factor generator 226, in response to determining that the audio context indicates a quieter environment, generates the attenuation factor 215 corresponding to higher attenuation (e.g., greater sound damping) of the (delayed) audio signal 203 (e.g., corresponding to delayed diffuse noise).

The audio mixer 148A mixes the attenuated audio signal 217 with each of the one or more enhanced audio signals 151 to generate the one or more stereo audio signals 149. For example, the audio mixer 148A mixes the attenuated audio signal 217 with each of the enhanced mono audio signal 143A and the enhanced mono audio signal 143B to generate a stereo audio signal 149A and a stereo audio signal 149B, respectively. The enhanced mono audio signal 143A may correspond to an enhanced left channel of a stereo audio signal, such as a stereo speech signal, and the enhanced mono audio signal 143B may correspond to an enhanced right channel of a stereo audio signal, such as the stereo speech signal. The one or more enhanced mono audio signals 143 include signal enhanced sounds (e.g., noise suppressed speech) and the audio signal 155 is based on the background audio signal 167 (e.g., diffuse noise from the leaves) and not based on the one or more directional audio signals 165 (e.g., the car noise). In this example, the one or more stereo audio signals 149 include speech and diffuse noise (e.g., from leaves) and do not include the directional noise (e.g., the car noise).

Referring to FIG. 2B, a diagram of an illustrative aspect of an audio mixer 148B is shown. In a particular aspect, the audio mixer 148B corresponds to an implementation of the audio mixer 148 of FIG. 1A.

The audio mixer 148B includes a neural network 258 configured to process one or more inputs of the audio mixer 148A of FIG. 2A to generate the one or more stereo audio signals 149. In a particular aspect, the neural network 258 is trained to generate the one or more stereo audio signals 149 that approximate the one or more stereo audio signals 149 generated by the audio mixer 148A of FIG. 2A. For example, the audio mixer 148B generates one or more input feature values based on the one or more enhanced audio signals 151 (e.g., the one or more enhanced mono audio signals 143), the background audio signal 167, the one or more input audio signals 125, or a combination thereof, and provides the one or more input feature values to the neural network 258. Audio feature extraction (not shown) may be performed on the one or more input audio signals to extract the one or more input feature values. Exemplary features include but are not limited to amplitude envelope of a signal, root mean square energy, and zero-crossing rate. The neural network 258 processes the one or more input feature values to generate one or more output feature values of the one or more stereo audio signals 149.

In a particular aspect, the neural network 258 includes an input layer, an output layer, and one or more hidden layers between the input layer and the output layer. In some implementations, the one or more hidden layers include fully connected layers, one or more convolution layers, or both. In some implementations, the one or more hidden layers include at least one recurrent layer, such as a long short-term memory (LSTM) layer, a gated recurrent unit (GRU) layer, or another recurrent neural network structure.

In a particular implementation, the input layer of the neural network 258 includes at least one input node for each signal input to the neural network 258. For example, the input layer of the neural network 258 may include at least one input node for feature values derived from the enhanced mono audio signal 143A, at least one input node for feature values derived from the enhanced mono audio signal 143B, at least one input node for feature values derived from the background audio signal 167, and optionally at least one input node for feature values derived from each of the input audio signal(s) 125.

In a particular implementation, the output layer of the neural network 258 includes two nodes corresponding to a right-channel stereo output node and a left-channel stereo output node. For example, the left-channel stereo output node may output the stereo audio signal 149A and the right-channel stereo output node may output the stereo audio signal 149B.

During training of the neural network 258, the audio mixer 148B (or another training component of a device) generates a loss metric based on a comparison of the one or more stereo audio signals 149 generated by the audio mixer 148A of FIG. 2A with the one or more stereo audio signals 149 generated by the neural network 258, and iteratively updates (e.g., weights and biases of) the neural network 258 to reduce the loss metric. In some aspects, the neural network 258 is considered trained when the loss metric satisfies a loss threshold.

Referring to FIG. 2C, a diagram of an illustrative neural network 258 configured and trained to perform operations of the audio mixer 148 of FIG. 1A is shown. In some examples, the audio mixer 148A of FIG. 2A or the audio mixer 148B of FIG. 2B can be implemented using the neural network 258 of FIG. 2C. In some alternative examples, the audio mixer 148A or the audio mixer 148B can be implemented using traditional audio mixing techniques.

The neural network 258 is configured to process one or more inputs of the audio mixer 148A of FIG. 2A to generate the one or more stereo audio signals 149. The neural network 258 is trained to generate the one or more stereo audio signals 149 that approximate the one or more stereo audio signals 149 generated by the audio mixer 148A of FIG. 2A. For example, the neural network 258 may be included within the audio mixer 148B of FIG. 2B.

In the example illustrated in FIG. 2C, the neural network 258 includes an input layer 270, an output layer 276, and one or more hidden layers 274 coupled between the input layer 270 and the output layer 276. For example, in FIG. 2C, the hidden layers 274 include a hidden layer 274A, which is coupled to the input layer 270 and to a hidden layer 274B and include the hidden layer 274B, which is coupled to the hidden layer 274A and to the output layer 276. Although two hidden layers 274 are illustrated in FIG. 2C, the neural network 258 may include fewer than two hidden layers 274 (e.g., a single hidden layer 274) or more than two hidden layers 274.

In FIG. 2C, the input layer 270 includes at least one input node for each signal that is to be input to the neural network 258. In particular, the input layer 270 of FIG. 2C includes at least two input nodes to receive enhanced audio signals 151A and 151B, respectively. In the example illustrated in FIG. 2C, the enhanced audio signal 151A corresponds to the enhanced mono audio signal 143A, and the enhanced audio signal 151B corresponds to the enhanced mono audio signal 143B, e.g., based on audio signals captured by different subgroups of the one or more microphones 120. Additionally, the input layer 270 of FIG. 2C includes at least one input node for feature values derived from the background audio signal 167 and optionally at least one input node for feature values derived from each of the input audio signal(s) 125.

In FIG. 2C, ellipses between nodes of the input layer 270 indicate that while four nodes are illustrated (corresponding to one node per signal that is to be input to the neural network 258), the input layer 270 may include more than four nodes. For example, one or more of the audio signals 143A, 143B, 167, or 125 may be encoded into a multibit feature vector for input to the neural network 258. As an example, the background audio signal 167 may be sampled to generate time-windowed samples.

Each time-windowed sample may be transformed to a frequency domain signal. Each frequency domain signal may be encoded as an N-bit, e.g., 16-bit, feature vector with N being a non-zero power of two. In this example, each sample of the background audio signal 167 is represented by 16 bits, and the input layer 270 may include 16 nodes to receive the 16 bits of the features of the background audio signal 167. In other examples, feature vectors larger than or smaller than 16 bits are used to represent one or more of the audio signals 143A, 143B, 167, or 125. Further, the feature vectors used to represent each of the audio signals 143A, 143B, 167, or 125 need not be of the same size. To illustrate, the enhanced audio signals 151 may be represented with higher fidelity (and a corresponding larger number of bits) than the background audio signal 167. In other words, the neural network 258 may include a larger number of input nodes per input signal for the one or more enhanced mono audio signals as compared to the other signals, e.g., the background audio signal.

In the example of FIG. 2C, the hidden layer 274A is fully connected to the input layer 270 and to the hidden layer 274B, and each node of the hidden layer 274A is associated with a respective one of a plurality of biases 272A. In some aspects, a bias value of a node tends to shift an output of the node independently of an input of the node. Likewise, the hidden layer 274B is fully connected to the hidden layer 274A and to the output layer 276, and each node of the hidden layer 274B is optionally associated with one of the biases 272B. In other implementations, the hidden layers 274 include other types of interconnection schemes, such as a convolution layer interconnection scheme. Optionally, one or more of the hidden layers 274 is a recurrent layer that includes feedback connections 278.

The output layer 276 of the neural network 258 includes at least two nodes corresponding to output nodes for features of the stereo audio signal 149A and the stereo audio signal 149B. Optionally, each of the nodes of the output layer 276 may be associated with a respective one of the biases 272C. In FIG. 2C, ellipses between the nodes of the output layer 276 indicate that while two nodes are illustrated (corresponding to one node per signal output by the neural network 258), the output layer 276 may include more than two nodes. For example, each of the stereo audio signals 149 may be represented in output of the neural network 258 as a multibit feature vector. In this example, the output layer 276 may include at least one node for each bit of the multibit feature vector of each stereo audio signal 149.

During training of the neural network 258, the audio mixer 148B (or another training component of a device) generates a loss metric based on a comparison of the one or more stereo audio signals 149 generated by the audio mixer 148A of FIG. 2A with the one or more stereo audio signals 149 generated by the neural network 258, and iteratively updates link weights between the various layers 270, 274, 276 and/or the biases 272 of the neural network 258 to reduce the loss metric. In some aspects, the neural network 258 is considered trained when the loss metric satisfies a loss threshold.

Referring to FIG. 3A, another diagram of an illustrative aspect of an audio mixer 148A is shown. In a particular aspect, the audio mixer 148A corresponds to an implementation of the audio mixer 148 of FIG. 1A.

In the example illustrated in FIG. 3A, the one or more enhanced audio signals 151 are the same as the one or more enhanced mono audio signals 143. For example, an enhanced audio signal 151A corresponds to the enhanced mono audio signal 143A, an enhanced audio signal 151B corresponds to the enhanced mono audio signal 143B, and so on.

The audio mixer 148A generates the one or more audio signals 155 based on the one or more directional audio signals 165. For example, the audio mixer 148A applies a delay 302 to the one or more directional audio signals 165 to generate one or more delayed audio signals 303. In some aspects, an amount of the delay 302 is based on the user input 103 of FIG. 1A, a configuration setting, a default delay, or a combination thereof.

Additionally or alternatively, the audio mixer 148A applies one or more panning operations 316 to the one or more (delayed) audio signals 303 to generate one or more panned audio signals 317. The one or more panned audio signals 317 correspond to the one or more audio signals 155. For example, a panned audio signal 317A and a panned audio signal 317B correspond to the audio signal 155A and the audio signal 155B, respectively. In an example, a pan factor generator 326 of the audio mixer 148A determines one or more pan factors 315 (e.g., gains, delays, or both) based on the visual context 147, a source direction selection 347, or both. As an example, the visual context 147 indicates a particular location (e.g., absolute location, relative location, or both) of the audio source 184A in a visual scene represented by the image data 127 of FIG. 1A. In another example, the source direction selection 347 indicates a selection of a particular location (e.g., absolute location, relative location, or both) of the audio source 184A in a soundscape, in a visual scene, or both. To illustrate, the source direction selection 347 indicates an audio source direction, an audio source distance, or both, relative to a notional listener in the soundscape, the visual scene, or both.

In some examples, the audio analyzer 140 determines the source direction selection 347 based on hand gesture detection, head tracking, eye gaze direction, a user interface input, or a combination thereof. In a particular aspect, the source direction selection 347 corresponds to a user input 103 of FIG. 1A indicating a selection of the particular location for the audio source 184A in a soundscape, in a visual scene, or both. To illustrate, the user input 103 can correspond to at least one of a mouse input, a keyboard input, eye gaze direction, head direction, a hand gesture, a touchscreen input, or another type of user selection of the particular location.

In a particular aspect, the particular location indicated by the visual context 147, the source direction selection 347, or both, corresponds to an estimated location of the audio source 184A, a target (e.g., desired) location of the audio source 184A, or both. The pan factor generator 326, in response to determining that the particular location (indicated by the visual context 147, the source direction selection 347, or both) corresponds to left of center in the visual scene, generates a pan factor 315A with a lower gain value than a pan factor 315B. The pan factor 315A (e.g., the lower gain value) is used to generate a stereo audio signal 149B (e.g., a right channel signal) and the pan factor 315B (e.g., the higher gain value) is used to generate the stereo audio signal 149A (e.g., a left channel signal). The audio mixer 148A performs a panning operation 316A based on the pan factor 315A to a particular delayed audio signal of the one or more delayed audio signals 303 to generate the panned audio signal 317A. For example, the particular delayed audio signal is based on the directional audio signal 165A that represents speech of the audio source 184A and the audio mixer 148A performs the panning operation 316A to the particular delayed audio signal to generate the panned audio signal 317A. The audio mixer 148A mixes the enhanced mono audio signal 143B (e.g., enhanced second microphone sound) with the panned audio signal 317A to generate the stereo audio signal 149B (e.g., a right channel signal).

Additionally, the audio mixer 148A performs a panning operation 316B based on the pan factor 315B to the particular delayed audio signal to generate the panned audio signal 317B. The audio mixer 148A mixes the enhanced mono audio signal 143A with the panned audio signal 317B to generate the stereo audio signal 149A. The speech from the audio source 184A is thus more perceptible in the stereo audio signal 149A (e.g., the left channel signal) as compared to the stereo audio signal 149B (e.g., the right channel signal). In some implementations, the pan factors 315 dynamically change over time as the audio source 184A moves from left to right.

In some implementations, instead of panning the one or more (delayed) audio signals 303, the audio mixer 148A pans the one or more enhanced mono audio signals 143 based on the visual context 147, the source direction selection 347, or both, as described with reference to FIG. 5A. In examples in which the one or more stereo audio signals 149 are based on the one or more directional audio signals 165 (e.g., the one or more delayed audio signals 303) and not based on the background audio signal 167 (e.g., the delayed audio signal 203), the stereo audio signals 149 include speech and directional noise and do not include the diffuse noise.

Referring to FIG. 3B, another diagram of an illustrative aspect of an audio mixer 148B is shown. In a particular aspect, the audio mixer 148B corresponds to an implementation of the audio mixer 148 of FIG. 1A.

The audio mixer 148B includes a neural network 358 configured to process one or more inputs of the audio mixer 148A of FIG. 3A to generate the one or more stereo audio signals 149. In a particular aspect, the neural network 358 is trained to generate the one or more stereo audio signals 149 that approximate the one or more stereo audio signals 149 generated by the audio mixer 148A of FIG. 3A. For example, the audio mixer 148B generates one or more input feature values based on the one or more enhanced audio signals 151 (e.g., the one or more enhanced mono audio signals 143), the one or more directional audio signals 165, the visual context 147, the source direction selection 347, or a combination thereof, and provides the one or more input feature values to the neural network 358. The neural network 358 processes the one or more input feature values to generate one or more output feature values of the one or more stereo audio signals 149.

In a particular aspect, the neural network 358 includes an input layer, an output layer, and one or more hidden layers between the input layer and the output layer. In some implementations, the one or more hidden layers include fully connected layers, one or more convolution layers, or both. In some implementations, the one or more hidden layers include at least one recurrent layer, such as a LSTM layer, a GRU layer, or another recurrent neural network structure.

In a particular implementation, the input layer of the neural network 358 includes at least one input node for each signal input to the neural network 358. For example, the input layer of the neural network 358 may include at least one input node for feature values derived from the enhanced mono audio signal 143A, at least one input node for feature values derived from the enhanced mono audio signal 143B, at least one input node for feature values derived from each of the directional audio signal(s) 165, and optionally at least one input node for feature values derived from the visual context 147 and/or the source direction selection 347.

In a particular implementation, the output layer of the neural network 358 includes two nodes corresponding to a right-channel stereo output node and a left-channel stereo output node. For example, the left-channel stereo output node may output the stereo audio signal 149A, and the right-channel stereo output node may output the stereo audio signal 149B.

During training of the neural network 358, the audio mixer 148B (or another training component of a device) generates a loss metric based on a comparison of the one or more stereo audio signals 149 generated by the audio mixer 148A of FIG. 3A with the one or more stereo audio signals 149 generated by the neural network 358, and iteratively updates (e.g., weights and biases of) the neural network 358 to reduce the loss metric. In some aspects, the neural network 358 is considered trained when the loss metric satisfies a loss threshold.

Referring to FIG. 3C, another diagram of an illustrative neural network 358 configured and trained to perform operations of the audio mixer 148B of FIG. 3B is shown. The neural network 358 is configured to process one or more inputs of the audio mixer 148A of FIG. 3A to generate the one or more stereo audio signals 149. The neural network 358 is trained to generate the one or more stereo audio signals 149 that approximate the one or more stereo audio signals 149 generated by the audio mixer 148A of FIG. 3A. For example, the neural network 358 may be included within the audio mixer 148B of FIG. 3B.

In the example illustrated in FIG. 3C, the neural network 358 includes an input layer 270, an output layer 276, and one or more hidden layers 274 coupled between the input layer 270 and the output layer 276. For example, in FIG. 3C, the hidden layers 274 include a hidden layer 274A, which is coupled to the input layer 270 and to a hidden layer 274B and include the hidden layer 274B, which is coupled to the hidden layer 274A and to the output layer 276. Although two hidden layers 274 are illustrated in FIG. 3C, the neural network 358 may include fewer than two hidden layers 274 (e.g., a single hidden layer 274) or more than two hidden layers 274.

In FIG. 3C, the input layer 270 includes at least one input node for each signal that is to be input to the neural network 358. In particular, the input layer 270 of FIG. 3C includes at least two input nodes to receive enhanced audio signals 151A and 151B, respectively. In the example illustrated in FIG. 3C, the enhanced audio signal 151A corresponds to the enhanced mono audio signal 143A, and the enhanced audio signal 151B corresponds to the enhanced mono audio signal 143B. Additionally, the input layer 270 of FIG. 3C includes at least one input node for feature values derived from each of the directional audio signal(s) 165 and at least one input node for feature values derived from the visual context 147 and/or the source direction selection 347.

In FIG. 3C, ellipses between nodes of the input layer 270 indicate that while four nodes are illustrated, the input layer 270 may include more than four nodes. For example, one or more of the audio signals 143A, 143B, or 165 may be encoded into a multibit feature vector for input to the neural network 358, as described above with reference to FIG. 2C.

In the example of FIG. 3C, the hidden layer 274A is fully connected to the input layer 270 and to the hidden layer 274B, and each node of the hidden layer 274A is optionally associated with a respective one of the plurality of biases 272A. Likewise, the hidden layer 274B is fully connected to the hidden layer 274A and to the output layer 276, and each node of the hidden layer 274B is optionally associated with a respective one of the biases 272B. In other implementations, the hidden layers 274 include other types of interconnection schemes, such as a convolution layer interconnection scheme. Optionally, one or more of the hidden layers 274 is a recurrent layer that includes feedback connections 278.

The output layer 276 of the neural network 358 includes at least two nodes corresponding to output nodes for features of the stereo audio signal 149A and the stereo audio signal 149B. Optionally, each of the nodes of the output layer 276 may be associated with a respective one of the biases 272C. In FIG. 3C, ellipses between the nodes of the output layer 276 indicate that while two nodes are illustrated (corresponding to one node per signal output by the neural network 358), the output layer 276 may include more than two nodes. For example, each of the stereo audio signals 149 may be represented in output of the neural network 358 as a multibit feature vector. In this example, the output layer 276 may include at least one node for each bit of the multibit feature vector of each stereo audio signal 149.

During training of the neural network 358, the audio mixer 148B (or another training component of a device) generates a loss metric based on a comparison of the one or more stereo audio signals 149 generated by the audio mixer 148A of FIG. 3A with the one or more stereo audio signals 149 generated by the neural network 358, and iteratively updates link weights between the various layers 270, 274, 276 and/or the biases 272 of the neural network 358 to reduce the loss metric. In some aspects, the neural network 358 is considered trained when the loss metric satisfies a loss threshold.

Referring to FIG. 4A, another diagram of an illustrative aspect of an audio mixer 148A is shown. In a particular aspect, the audio mixer 148A corresponds to an implementation of the audio mixer 148 of FIG. 1A.

The audio mixer 148A performs, based on the visual context 147, the source direction selection 347, or both, one or more binauralization operations 416 on the one or more enhanced mono audio signals 143 to generate one or more binaural audio signals 417. The one or more binaural audio signals 417 correspond to the one or more enhanced audio signals 151. For example, the audio mixer 148A performs a binauralization operation 416A on the enhanced mono audio signal 143A and a binauralization operation 416B on the enhanced mono audio signal 143B to generate a binaural audio signal 417A and a binaural audio signal 417B, respectively. The binaural audio signal 417A and the binaural audio signal 417B correspond to the enhanced audio signal 151A and the enhanced audio signal 151B, respectively.

As an example, the visual context 147, the source direction selection 347, or both, indicate a particular location (e.g., a relative location, an absolute location, or both) of the audio source 184A in a visual scene represented by the image data 127 of FIG. 1A. Performing the binauralization operation 416A includes applying, based on the particular location of the audio source 184A, a head-related transfer function (HRTF) to the enhanced mono audio signal 143A to generate the binaural audio signal 417A (e.g., an enhanced binaural signal). The audio mixer 148A mixes the binaural audio signal 417A with one or more delayed audio signals 303 to generate the stereo audio signal 149A, and mixes the binaural audio signal 417B with the one or more delayed audio signals 303 to generate the stereo audio signal 149B. The one or more delayed audio signals 303 may be generated based on one or more directional audio signal(s) 165 (e.g., by applying a delay 302), as described with reference to FIG. 3A.

In this example, the one or more stereo audio signals 149 are based on the one or more directional audio signals 165 (e.g., the one or more delayed audio signals 303) and not based on the background audio signal 167 (e.g., the delayed audio signal 203 of FIG. 2A). As a result, the stereo audio signals 149 include speech and directional noise and do not include the diffuse noise.

Referring to FIG. 4B, another diagram of an illustrative aspect of an audio mixer 148B is shown. In a particular aspect, the audio mixer 148B corresponds to an implementation of the audio mixer 148 of FIG. 1A.

The audio mixer 148B includes a neural network 458 configured to process one or more inputs of the audio mixer 148A of FIG. 4A to generate the one or more stereo audio signals 149. In a particular aspect, the neural network 458 is trained to generate the one or more stereo audio signals 149 that approximate the one or more stereo audio signals 149 generated by the audio mixer 148A of FIG. 4A. For example, the audio mixer 148B generates one or more input feature values based on the one or more enhanced audio signals 151 (e.g., the one or more enhanced mono audio signals 143), the one or more directional audio signals 165, the visual context 147, the source direction selection 347, or a combination thereof, and provides the one or more input feature values to the neural network 458. The neural network 458 processes the one or more input feature values to generate one or more output feature values of the one or more stereo audio signals 149.

In a particular aspect, the neural network 458 includes an input layer, an output layer, and one or more hidden layers between the input layer and the output layer. In some implementations, the one or more hidden layers include fully connected layers, one or more convolution layers, or both. In some implementations, the one or more hidden layers include at least one recurrent layer, such as a LSTM layer, a GRU layer, or another recurrent neural network structure.

In a particular implementation, the input layer of the neural network 458 includes at least one input node for each signal input to the neural network 458. For example, the input layer of the neural network 458 may include at least one input node for feature values derived from the enhanced mono audio signal 143A, at least one input node for feature values derived from the enhanced mono audio signal 143B, at least one optional input node for feature values derived from the visual context 147 and/or the source direction selection 347, and at least one input node for feature values derived from each of the directional audio signal(s) 165.

In a particular implementation, the output layer of the neural network 458 includes two nodes corresponding to a right-channel stereo output node and a left-channel stereo output node. For example, the left-channel stereo output node may output the stereo audio signal 149A and the right-channel stereo output node may output the stereo audio signal 149B.

During training of the neural network 458, the audio mixer 148B (or another training component of a device) generates a loss metric based on a comparison of the one or more stereo audio signals 149 generated by the audio mixer 148A of FIG. 4A with the one or more stereo audio signals 149 generated by the neural network 458, and iteratively updates (e.g., weights and biases of) the neural network 458 to reduce the loss metric. In some aspects, the neural network 458 is considered trained when the loss metric satisfies a loss threshold.

Referring to FIG. 4C, another diagram of an illustrative neural network 458 configured and trained to perform operations of the audio mixer 148B of FIG. 4B is shown. The neural network 458 is configured to process one or more inputs of the audio mixer 148A of FIG. 4A to generate the one or more stereo audio signals 149. The neural network 458 is trained to generate the one or more stereo audio signals 149 that approximate the one or more stereo audio signals 149 generated by the audio mixer 148A of FIG. 4A. For example, the neural network 458 may be included within the audio mixer 148B of FIG. 4B.

In the example illustrated in FIG. 4C, the neural network 458 includes an input layer 270, an output layer 276, and one or more hidden layers 274 coupled between the input layer 270 and the output layer 276. For example, in FIG. 4C, the hidden layers 274 include a hidden layer 274A, which is coupled to the input layer 270 and to a hidden layer 274B and include the hidden layer 274B, which is coupled to the hidden layer 274A and to the output layer 276. Although two hidden layers 274 are illustrated in FIG. 4C, the neural network 458 may include fewer than two hidden layers 274 (e.g., a single hidden layer 274) or more than two hidden layers 274.

In FIG. 4C, the input layer 270 includes at least one input node for each signal that is to be input to the neural network 458. In particular, the input layer 270 of FIG. 4C includes at least two input nodes to receive enhanced audio signals 151A and 151B, respectively. In the example illustrated in FIG. 4C, the enhanced audio signal 151A corresponds to the enhanced mono audio signal 143A, and the enhanced audio signal 151B corresponds to the enhanced mono audio signal 143B. Additionally, the input layer 270 of FIG. 4C includes at least one input node for feature values derived from each of the directional audio signal(s) 165 and optionally, at least one input node for feature values derived from the visual context 147 and/or the source direction selection 347.

In FIG. 4C, ellipses between nodes of the input layer 270 indicate that while four nodes are illustrated, the input layer 270 may include more than four nodes. For example, one or more of the audio signals 143A, 143B, or 165 may be encoded into a multibit feature vector for input to the neural network 458, as described above with reference to FIG. 2C.

In the example of FIG. 4C, the hidden layer 274A is fully connected to the input layer 270 and to the hidden layer 274B, and each node of the hidden layer 274A is optionally associated with a respective one of the plurality of biases 272A. Likewise, the hidden layer 274B is fully connected to the hidden layer 274A and to the output layer 276, and each node of the hidden layer 274B is optionally associated with a respective one of the biases 272B. In other implementations, the hidden layers 274 include other types of interconnection schemes, such as a convolution layer interconnection scheme. Optionally, one or more of the hidden layers 274 is a recurrent layer that includes feedback connections 278.

The output layer 276 of the neural network 458 includes at least two nodes corresponding to output nodes for features of the stereo audio signal 149A and the stereo audio signal 149B. Optionally, each of the nodes of the output layer 276 may be associated with a respective one of the biases 272C. In FIG. 4C, ellipses between the nodes of the output layer 276 indicate that while two nodes are illustrated (corresponding to one node per signal output by the neural network 458), the output layer 276 may include more than two nodes. For example, each of the stereo audio signals 149 may be represented in output of the neural network 458 as a multibit feature vector. In this example, the output layer 276 may include at least one node for each bit of the multibit feature vector of each stereo audio signal 149.

During training of the neural network 458, the audio mixer 148B (or another training component of a device) generates a loss metric based on a comparison of the one or more stereo audio signals 149 generated by the audio mixer 148A of FIG. 4A with the one or more stereo audio signals 149 generated by the neural network 458, and iteratively updates link weights between the various layers 270, 274, 276 and/or the biases 272 of the neural network 458 to reduce the loss metric. In some aspects, the neural network 458 is considered trained when the loss metric satisfies a loss threshold.

Referring to FIG. 5A, another diagram of an illustrative aspect of an audio mixer 148A is shown. In a particular aspect, the audio mixer 148A corresponds to an implementation of the audio mixer 148 of FIG. 1A.

The audio mixer 148A performs, based on the visual context 147, the source direction selection 347, or both, one or more panning operations 516 on the one or more enhanced mono audio signals 143 to generate one or more panned audio signals 517. The one or more panned audio signals 517 correspond to the one or more enhanced audio signals 151. For example, the audio mixer 148A performs a panning operation 516A on the enhanced mono audio signal 143A and a panning operation 516B on the enhanced mono audio signal 143B to generate a panned audio signal 517A and a panned audio signal 517B, respectively. The panned audio signal 517A and the panned audio signal 517B correspond to the enhanced audio signal 151A and the enhanced audio signal 151B, respectively.

As an example, the visual context 147, the source direction selection 347, or both, indicate a particular location (e.g., a relative location, an absolute location, or both) of the audio source 184A in a visual scene represented by the image data 127 of FIG. 1A. Performing the panning operation 516A includes applying, based on the particular location of the audio source 184A, a first pan factor (e.g., a gain, a delay, or both) to the enhanced mono audio signal 143A to generate the panned audio signal 517A (e.g., an enhanced panned signal). Similarly, performing the panning operation 516B includes applying, based on the particular location of the audio source 184A, a second pan factor (e.g., a gain, a delay, or both) to the enhanced mono audio signal 143B to generate the panned audio signal 517B (e.g., an enhanced panned signal).

The audio mixer 148A includes a reverberation generator 544 that uses a reverberation model 554 to process the one or more directional audio signals 165, the background audio signal 167, or both, to generate a reverberation signal 545. The audio mixer 148A mixes each of the one or more panned audio signals 517 with the reverberation signal 545 to generate the one or more stereo audio signals 149. For example, the audio mixer 148A mixes each of the panned audio signal 517A and the panned audio signal 517B with the reverberation signal 545 to generate the stereo audio signal 149A and the stereo audio signal 149B, respectively.

In this example, the one or more stereo audio signals 149 include reverberation that is based on the one or more directional audio signals 165, the background audio signal 167, or both, and do not include the one or more directional audio signals 165 or the background audio signal 167. As a result, the stereo audio signals 149 include reverberation and do not include background noise (e.g., car noise or wind noise).

Referring to FIG. 5B, another diagram of an illustrative aspect of an audio mixer 148B is shown. In a particular aspect, the audio mixer 148B corresponds to an implementation of the audio mixer 148 of FIG. 1A.

The audio mixer 148B includes a neural network 558 configured to process one or more inputs of the audio mixer 148A of FIG. 5A to generate the one or more stereo audio signals 149. The neural network 558 is trained to generate the one or more stereo audio signals 149 that approximate the one or more stereo audio signals 149 generated by the audio mixer 148A of FIG. 5A. For example, the audio mixer 148B generates one or more input feature values based on the one or more enhanced audio signals 151 (e.g., the one or more enhanced mono audio signals 143), the one or more directional audio signals 165, the background audio signal 167, the visual context 147, the source direction selection 347, or a combination thereof, and provides the one or more input feature values to the neural network 558. The neural network 558 processes the one or more input feature values to generate one or more output feature values of the one or more stereo audio signals 149.

In a particular aspect, the neural network 558 includes an input layer, an output layer, and one or more hidden layers between the input layer and the output layer. In some implementations, the one or more hidden layers include fully connected layers, one or more convolution layers, or both. In some implementations, the one or more hidden layers include at least one recurrent layer, such as a LSTM layer, a GRU layer, or another recurrent neural network structure.

In a particular implementation, the input layer of the neural network 558 includes at least one input node for each signal input to the neural network 558. For example, the input layer of the neural network 558 may include at least one input node for feature values derived from the enhanced mono audio signal 143A, at least one input node for feature values derived from the enhanced mono audio signal 143B, at least one input node for feature values derived from the visual context 147 and/or the source direction selection 347, and optionally, at least one input node for feature values derived from each of the directional audio signal(s) 165, and/or at least one input node for feature values derived from the background audio signal 167.

In a particular implementation, the output layer of the neural network 558 includes two nodes corresponding to a right-channel stereo output node and a left-channel stereo output node. For example, the left-channel stereo output node may output the stereo audio signal 149A and the right-channel stereo output node may output the stereo audio signal 149B.

During training of the neural network 558, the audio mixer 148B (or another training component of a device) generates a loss metric based on a comparison of the one or more stereo audio signals 149 generated by the audio mixer 148A of FIG. 5A with the one or more stereo audio signals 149 generated by the neural network 558, and iteratively updates (e.g., weights and biases of) the neural network 558 to reduce the loss metric. In some aspects, the neural network 558 is considered trained when the loss metric satisfies a loss threshold.

Referring to FIG. 5C, another diagram of an illustrative neural network 558 configured and trained to perform operations of the audio mixer 148B of FIG. 5B is shown. The neural network 558 is configured to process one or more inputs of the audio mixer 148A of FIG. 5A to generate the one or more stereo audio signals 149. The neural network 558 is trained to generate the one or more stereo audio signals 149 that approximate the one or more stereo audio signals 149 generated by the audio mixer 148A of FIG. 5A. For example, the neural network 558 may be included within the audio mixer 148B of FIG. 5B.

In the example illustrated in FIG. 5C, the neural network 558 includes an input layer 270, an output layer 276, and one or more hidden layers 274 coupled between the input layer 270 and the output layer 276. For example, in FIG. 5C, the hidden layers 274 include a hidden layer 274A, which is coupled to the input layer 270 and to a hidden layer 274B and include the hidden layer 274B, which is coupled to the hidden layer 274A and to the output layer 276. Although two hidden layers 274 are illustrated in FIG. 5C, the neural network 558 may include fewer than two hidden layers 274 (e.g., a single hidden layer 274) or more than two hidden layers 274.

In FIG. 5C, the input layer 270 includes at least one input node for each signal that is to be input to the neural network 558. In particular, the input layer 270 of FIG. includes at least two input nodes to receive enhanced audio signals 151A and 151B, respectively. In the example illustrated in FIG. 5C, the enhanced audio signal 151A corresponds to the enhanced mono audio signal 143A, and the enhanced audio signal 151B corresponds to the enhanced mono audio signal 143B. Additionally, the input layer 270 of FIG. 5C may include at least one input node for feature values derived from the background audio signal 167 and/or at least one input node for feature values derived from each of the directional audio signal(s) 165. The input layer 270 of FIG. additionally includes at least one input node for feature values derived from the visual context 147 and/or the source direction selection 347.

In FIG. 5C, ellipses between nodes of the input layer 270 indicate that while five nodes are illustrated, the input layer 270 may include more than five nodes. For example, one or more of the audio signals 143A, 143B, 167, or 165 may be encoded into a multibit feature vector for input to the neural network 558, as described above with reference to FIG. 2C.

In the example of FIG. 5C, the hidden layer 274A is fully connected to the input layer 270 and to the hidden layer 274B, and each node of the hidden layer 274A is optionally associated with a respective one of the biases 272A. Likewise, the hidden layer 274B is fully connected to the hidden layer 274A and to the output layer 276, and each node of the hidden layer 274B is optionally associated with a respective one of the biases 272B. In other implementations, the hidden layers 274 include other types of interconnection schemes, such as a convolution layer interconnection scheme. Optionally, one or more of the hidden layers 274 is a recurrent layer that includes feedback connections 278.

The output layer 276 of the neural network 558 includes at least two nodes corresponding to output nodes for features of the stereo audio signal 149A and the stereo audio signal 149B. Optionally, each of the nodes of the output layer 276 may be associated with a respective one of the biases 272C. In FIG. 5C, ellipses between the nodes of the output layer 276 indicate that while two nodes are illustrated (corresponding to one node per signal output by the neural network 558), the output layer 276 may include more than two nodes. For example, each of the stereo audio signals 149 may be represented in output of the neural network 558 as a multibit feature vector. In this example, the output layer 276 may include at least one node for each bit of the multibit feature vector of each stereo audio signal 149.

During training of the neural network 558, the audio mixer 148B (or another training component of a device) generates a loss metric based on a comparison of the one or more stereo audio signals 149 generated by the audio mixer 148A of FIG. 5A with the one or more stereo audio signals 149 generated by the neural network 558, and iteratively updates link weights between the various layers 270, 274, 276 and/or the biases 272 of the neural network 558 to reduce the loss metric. In some aspects, the neural network 558 is considered trained when the loss metric satisfies a loss threshold.

Referring to FIG. 6A, another diagram of an illustrative aspect of an audio mixer 148A is shown. In a particular aspect, the audio mixer 148A corresponds to an implementation of the audio mixer 148 of FIG. 1A.

The audio mixer 148A includes a reverberation generator 644 that uses a reverberation model 654 to generate a synthesized reverberation signal 645 (e.g., not based on reverberation extracted from audio signals as in FIG. 5A) corresponding to the location context 137, the visual context 147, or both. In some implementations, the visual context 147 is based on surfaces (e.g., walls, ceilings, floor, objects, etc.) of an environment, room geometry, or both. For example, the reverberation model 654, in response to the visual context 147, the location context 137, or both, indicating an environment corresponding to a conference hall, generates the synthesized reverberation signal 645 corresponding to a large room. As another example, the reverberation model 654, responsive to the visual context 147 indicating highly reflective surfaces (e.g., metal surfaces) in a larger room, generates the synthesized reverberation signal 645 corresponding to a longer reverberation time. Alternatively, the reverberation model 654, responsive to the visual context 147 indicating less reflective surfaces (e.g., fabric surfaces) or a smaller room, generates the synthesized reverberation signal 645 corresponding to a shorter reverberation time.

The audio mixer 148A mixes each of the one or more panned audio signals 517 (e.g., generated as described with reference to FIG. 5A) with the synthesized reverberation signal 645 to generate the one or more stereo audio signals 149. For example, the audio mixer 148A mixes each of the panned audio signal 517A and the panned audio signal 517B with the synthesized reverberation signal 645 to generate the stereo audio signal 149A and the stereo audio signal 149B, respectively.

In this example, the one or more stereo audio signals 149 include reverberation that is based on the location context 137, the visual context 147, or both, and are not based on the one or more directional audio signals 165 or the background audio signal 167 of FIG. 1A. As a result, the stereo audio signals 149 include reverberation and do not include background noise (e.g., car noise or wind noise).

Referring to FIG. 6B, another diagram of an illustrative aspect of an audio mixer 148B is shown. In a particular aspect, the audio mixer 148B corresponds to an implementation of the audio mixer 148 of FIG. 1A.

The audio mixer 148B includes a neural network 658 configured to process one or more inputs of the audio mixer 148A of FIG. 6A to generate the one or more stereo audio signals 149. The neural network 658 is trained to generate the one or more stereo audio signals 149 that approximate the one or more stereo audio signals 149 generated by the audio mixer 148A of FIG. 6A. For example, the audio mixer 148B generates one or more input feature values based on the one or more enhanced audio signals 151 (e.g., the one or more enhanced mono audio signals 143), the location context 137, the visual context 147, the source direction selection 347, or a combination thereof, and provides the one or more input feature values to the neural network 658. The neural network 658 processes the one or more input feature values to generate one or more output feature values of the one or more stereo audio signals 149.

In a particular aspect, the neural network 658 includes an input layer, an output layer, and one or more hidden layers between the input layer and the output layer. In some implementations, the one or more hidden layers include fully connected layers, one or more convolution layers, or both. In some implementations, the one or more hidden layers include at least one recurrent layer, such as a LSTM layer, a GRU layer, or another recurrent neural network structure.

In a particular implementation, the input layer of the neural network 658 includes at least one input node for each signal input to the neural network 658. For example, the input layer of the neural network 658 may include at least one input node for feature values derived from the enhanced mono audio signal 143A, at least one input node for feature values derived from the enhanced mono audio signal 143B, and at least one input node for feature values derived from the visual context 147, the source direction selection 347, and/or the location context 137.

In a particular implementation, the output layer of the neural network 658 includes two nodes corresponding to a right-channel stereo output node and a left-channel stereo output node. For example, the left-channel stereo output node may output the stereo audio signal 149A and the right-channel stereo output node may output the stereo audio signal 149B.

During training of the neural network 658, the audio mixer 148B (or another training component of a device) generates a loss metric based on a comparison of the one or more stereo audio signals 149 generated by the audio mixer 148A of FIG. 6A with the one or more stereo audio signals 149 generated by the neural network 658, and iteratively updates (e.g., weights and biases of) the neural network 658 to reduce the loss metric. In some aspects, the neural network 658 is considered trained when the loss metric satisfies a loss threshold.

Referring to FIG. 6C, another diagram of an illustrative neural network 658 configured and trained to perform operations of the audio mixer 148B of FIG. 6B is shown. The neural network 658 is configured to process one or more inputs of the audio mixer 148A of FIG. 6A to generate the one or more stereo audio signals 149. The neural network 658 is trained to generate the one or more stereo audio signals 149 that approximate the one or more stereo audio signals 149 generated by the audio mixer 148A of FIG. 6A. For example, the neural network 658 may be included within the audio mixer 148B of FIG. 6B.

In the example illustrated in FIG. 6C, the neural network 658 includes an input layer 270, an output layer 276, and one or more hidden layers 274 coupled between the input layer 270 and the output layer 276. For example, in FIG. 6C, the hidden layers 274 include a hidden layer 274A, which is coupled to the input layer 270 and to a hidden layer 274B and include the hidden layer 274B, which is coupled to the hidden layer 274A and to the output layer 276. Although two hidden layers 274 are illustrated in FIG. 6C, the neural network 658 may include fewer than two hidden layers 274 (e.g., a single hidden layer 274) or more than two hidden layers 274.

In FIG. 6C, the input layer 270 includes at least one input node for each signal that is to be input to the neural network 658. In particular, the input layer 270 of FIG. 6C includes at least two input nodes to receive enhanced audio signals 151A and 151B, respectively. In the example illustrated in FIG. 6C, the enhanced audio signal 151A corresponds to the enhanced mono audio signal 143A, and the enhanced audio signal 151B corresponds to the enhanced mono audio signal 143B. Additionally, the input layer 270 of FIG. 6C includes at least one input node for feature values derived from the visual context 147, the source direction selection 347, and/or the location context 137.

In FIG. 6C, ellipses between nodes of the input layer 270 indicate that while three nodes are illustrated, the input layer 270 may include more than three nodes. For example, one or more of the audio signals 143A or 143B may be encoded into a multibit feature vector for input to the neural network 658, as described above with reference to FIG. 2C.

In the example of FIG. 6C, the hidden layer 274A is fully connected to the input layer 270 and to the hidden layer 274B, and each node of the hidden layer 274A is optionally associated with a respective one of the biases 272A. Likewise, the hidden layer 274B is fully connected to the hidden layer 274A and to the output layer 276, and each node of the hidden layer 274B is optionally associated with one of the biases 272B. In other implementations, the hidden layers 274 include other types of interconnection schemes, such as a convolution layer interconnection scheme. Optionally, one or more of the hidden layers 274 is a recurrent layer that includes feedback connections 278.

The output layer 276 of the neural network 658 includes at least two nodes corresponding to output nodes for features of the stereo audio signal 149A and the stereo audio signal 149B. Optionally, each of the nodes of the output layer 276 may be associated with a respective one of the biases 272C. In FIG. 6C, ellipses between the nodes of the output layer 276 indicate that while two nodes are illustrated (corresponding to one node per signal output by the neural network 658), the output layer 276 may include more than two nodes. For example, each of the stereo audio signals 149 may be represented in output of the neural network 658 as a multibit feature vector. In this example, the output layer 276 may include at least one node for each bit of the multibit feature vector of each stereo audio signal 149.

During training of the neural network 658, the audio mixer 148B (or another training component of a device) generates a loss metric based on a comparison of the one or more stereo audio signals 149 generated by the audio mixer 148A of FIG. 6A with the one or more stereo audio signals 149 generated by the neural network 658, and iteratively updates link weights between the various layers 270, 274, 276 and/or the biases 272 of the neural network 658 to reduce the loss metric. In some aspects, the neural network 658 is considered trained when the loss metric satisfies a loss threshold.

It should be understood that FIGS. 2A-6C provide non-limiting illustrative aspects of implementations of the audio mixer 148. Other implementations of the audio mixer 148 can include various other aspects. To illustrate, in some examples, the audio mixer 148 can generate the stereo audio signal 149A by mixing one of the one or more audio signals 155 with multiple of the one or more enhanced audio signals 151.

Referring to FIG. 7, a diagram 700 is shown of the device 102 operable to perform audio signal enhancement of the one or more input audio signals 125 that are based on encoded data 749 received from a device 704. The device 102 includes the audio analyzer 140 coupled to a receiver 740.

During operation, the receiver 740 receives encoded data 749 from the device 704. The encoded data 749 represents the one or more input audio signals 125, the image data 127, the location data 163, or a combination thereof. For example, the encoded data 749 represents the sounds 185 of the one or more audio sources 184, images of the one or more audio sources 184, a location of an audio scene associated with the sounds 185, or a combination thereof. In some implementations, a decoder of the device 102 decodes the encoded data 749 to generate the one or more input audio signals 125, the image data 127, the location data 163, or a combination thereof.

As described with reference to FIG. 1A, the audio analyzer 140 processes the one or more input audio signals 125 based on the image data 127, the location data 163, or both, to generate the one or more stereo audio signals 149. The audio analyzer 140 provides the one or more stereo audio signals 149 to one or more speakers 722 to output sounds 785. The one or more stereo audio signals 149 (e.g., the sounds 785) include less noise than the one or more input audio signals 125 and more audio context than the one or more enhanced mono audio signals 143, as described with reference to FIG. 1A.

FIG. 8 illustrates an example of a device operable to transmit encoded data that is based on an enhanced audio signal, in accordance with some examples of the present disclosure.

Referring to FIG. 8, a diagram 800 is shown of the device 102 operable to transmit encoded data 849 to a device 804. The encoded data 849 corresponds to the one or more stereo audio signals 149 and the one or more stereo audio signals 149 are based on the one or more enhanced mono audio signals 143, as described with reference to FIG. 1A. The device 102 includes the audio analyzer 140 coupled to a transmitter 840.

During operation, the audio analyzer 140 obtains the one or more input audio signals 125, the image data 127, or both. In some aspects, the one or more input audio signals 125 correspond to a microphone output of the one or more microphones 120, and the image data 127 corresponds to a camera output of the one or more cameras 130. The one or more input audio signals 125 represent the sounds 185 of the audio sources 184. The audio analyzer 140 processes the one or more input audio signals 125, the image data 127, or both, to generate the one or more stereo audio signals 149. For example, as described with reference to FIG. 1A, the audio analyzer 140 performs signal enhancement to generate the one or more enhanced mono audio signals 143 and processes the one or more enhanced mono audio signals 143 to generate the one or more stereo audio signals 149.

The transmitter 840 transmits encoded data 849 to the device 804. The encoded data 849 is based on the one or more stereo audio signals 149. In some examples, an encoder of the device 102 encodes the one or more stereo audio signals 149 to generate the encoded data 849.

A decoder of the device 804 decodes the encoded data 849 to generate a decoded audio signal. The device 804 provides the decoded audio signal to one or more speakers 822 to output sounds 885.

In some implementations, the device 804 is the same as the device 704. For example, the device 102 receives the encoded data 749 from a second device and outputs the sounds 785 via the one or more speakers 722 while concurrently capturing the sounds 185 via the one or more microphones 120 and sending the encoded data 849 to the second device.

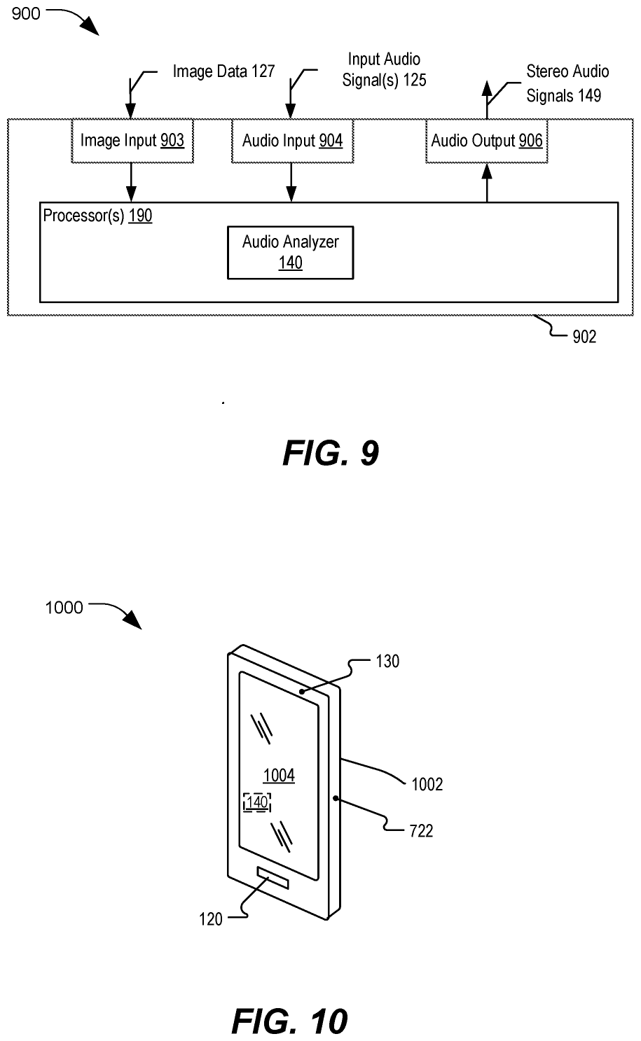

FIG. 9 depicts an implementation 900 of the device 102 as an integrated circuit 902 that includes the one or more processors 190. The integrated circuit 902 also includes an audio input 904, such as one or more bus interfaces, to enable the one or more input audio signals 125 to be received for processing. In some aspects, the integrated circuit 902 includes an image input 903, such as one or more bus interfaces, to enable the image data 127 to be received for processing. The integrated circuit 902 also includes an audio output 906, such as a bus interface, to enable sending of an audio signal, such as the one or more stereo audio signals 149. The integrated circuit 902 enables implementation of audio signal enhancement as a component in a system, such as a mobile phone or tablet as depicted in FIG. 10, a headset as depicted in FIG. 11, a wearable electronic device as depicted in FIG. 12, a voice-controlled speaker system as depicted in FIG. 13, a camera as depicted in FIG. 14, a virtual reality, mixed reality, or augmented reality headset as depicted in FIG. 15, or a vehicle as depicted in FIG. 16 or FIG. 17.

FIG. 10 depicts an implementation 1000 in which the device 102 includes a mobile device 1002, such as a phone or tablet, as illustrative, non-limiting examples. The mobile device 1002 includes the one or more microphones 120, the one or more cameras 130, the one or more speakers 722, and a display screen 1004. Components of the one or more processors 190, including the audio analyzer 140, are integrated in the mobile device 1002 and are illustrated using dashed lines to indicate internal components that are not generally visible to a user of the mobile device 1002. In a particular example, user voice activity is detected in the one or more stereo audio signals 149 generated by the audio analyzer 140 and the user voice activity is processed to perform one or more operations at the mobile device 1002, such as to launch a graphical user interface or otherwise display other information associated with the user's speech at the display screen 1004 (e.g., via an integrated “smart assistant” application).

FIG. 11 depicts an implementation 1100 in which the device 102 includes a headset device 1102. The headset device 1102 includes the one or more microphones 120, the one or more cameras 130, the one or more speakers 722, or a combination thereof. Components of the one or more processors 190, including the audio analyzer 140, are integrated in the headset device 1102. In a particular example, user voice activity is detected in the one or more stereo audio signals 149 generated by the audio analyzer 140, which may cause the headset device 1102 to perform one or more operations at the headset device 1102, to transmit audio data corresponding to the user voice activity to a second device (not shown), such as the device 704 of FIG. 7 or the device 804 of FIG. 8, for further processing, or a combination thereof.

FIG. 12 depicts an implementation 1200 in which the device 102 includes a wearable electronic device 1202, illustrated as a “smart watch.” The audio analyzer 140, the one or more microphones 120, the one or more cameras 130, the one or more speakers 722, or a combination thereof, are integrated into the wearable electronic device 1202. In a particular example, user voice activity is detected in the one or more enhanced mono audio signals 143 generated by the audio analyzer 140 and the user voice activity is processed to perform one or more operations at the wearable electronic device 1202, such as to launch a graphical user interface or otherwise display other information associated with the user's speech at a display screen 1204 of the wearable electronic device 1202. To illustrate, the wearable electronic device 1202 may include the display screen 1204 that is configured to display a notification based on user speech detected by the wearable electronic device 1202. In a particular example, the wearable electronic device 1202 includes a haptic device that provides a haptic notification (e.g., vibrates) in response to detection of user voice activity. For example, the haptic notification can cause a user to look at the wearable electronic device 1202 to see a displayed notification indicating detection of a keyword spoken by the user. The wearable electronic device 1202 can thus alert a user with a hearing impairment or a user wearing a headset that the user's voice activity is detected.

FIG. 13 is an implementation 1300 in which the device 102 includes a wireless speaker and voice activated device 1302. The wireless speaker and voice activated device 1302 can have wireless network connectivity and is configured to execute an assistant operation. The one or more processors 190 including the audio analyzer 140, the one or more microphones 120, the one or more cameras 130, or a combination thereof, are included in the wireless speaker and voice activated device 1302. The wireless speaker and voice activated device 1302 also includes the one or more speakers 722. During operation, in response to receiving a verbal command identified as user speech in the one or more enhanced mono audio signals 143 generated by the audio analyzer 140, the wireless speaker and voice activated device 1302 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”).

FIG. 14 depicts an implementation 1400 in which the device 102 includes a portable electronic device that corresponds to a camera device 1402. In some aspects, the camera device 1402 includes the one or more cameras 130 of FIG. 1A. The audio analyzer 140, the one or more microphones 120, the one or more cameras 130, the one or more speakers 722, or a combination thereof, are included in the camera device 1402. During operation, in response to receiving a verbal command identified as user speech in the one or more enhanced mono audio signals 143 generated by the audio analyzer 140, the camera device 1402 can execute operations responsive to spoken user commands, such as to adjust image or video capture settings, image or video playback settings, or image or video capture instructions, as illustrative examples.

FIG. 15 depicts an implementation 1500 in which the device 102 includes a portable electronic device that corresponds to a virtual reality, mixed reality, or augmented reality headset 1502. The audio analyzer 140, the one or more microphones 120, the one or more cameras 130, the one or more speakers 722, or a combination thereof, are integrated into the headset 1502. In some examples, the headset 1502 receives the encoded data 749, processes the encoded data 749 to generate the one or more stereo audio signals 149, and provides the one or more stereo audio signals 149 to the one or more speakers 722, as described with reference to FIG. 7. In some aspects, user voice activity detection can be performed on the one or more enhanced mono audio signals 143 generated by the audio analyzer 140. A visual interface device is positioned in front of the user's eyes to enable display of augmented reality, mixed reality, or virtual reality images or scenes to the user while the headset 1502 is worn. In a particular example, the visual interface device is configured to display a notification indicating user speech detected in the audio signal.

FIG. 16 depicts an implementation 1600 in which the device 102 corresponds to, or is integrated within, a vehicle 1602, illustrated as a manned or unmanned aerial device (e.g., a package delivery drone). The audio analyzer 140, the one or more microphones 120, the one or more cameras 130, the one or more speakers 722, or a combination thereof, are integrated into the vehicle 1602. User voice activity detection can be performed on the one or more enhanced mono audio signals 143 generated by the audio analyzer 140, such as for delivery instructions from an authorized user of the vehicle 1602.

FIG. 17 depicts another implementation 1700 in which the device 102 corresponds to, or is integrated within, a vehicle 1702, illustrated as a car. The vehicle 1702 includes the one or more processors 190 including the audio analyzer 140. The vehicle 1702 also includes the one or more microphones 120, the one or more cameras 130, the one or more speakers 722, or a combination thereof. User voice activity detection can be performed on the one or more enhanced mono audio signals 143 generated by the audio analyzer 140. In some implementations, the one or more input audio signals 125 are received from interior microphones (e.g., the one or more microphones 120), such as for a voice command from an authorized passenger. For example, the user voice activity detection can be used to detect a voice command from an operator of the vehicle 1702 (e.g., from a parent to set a volume to 5 or to set a destination for a self-driving vehicle) and to disregard the voice of another passenger (e.g., a voice command from a child to set the volume to 10 or other passengers discussing another location). In some implementations, the one or more input audio signals 125 are received from external microphones (e.g., the one or more microphones 120), such as from an authorized user of the vehicle 1702. In a particular implementation, in response to identifying a verbal command in the one or more enhanced mono audio signals 143 generated by the audio analyzer 140, a voice activation system initiates one or more operations of the vehicle 1702 based on one or more keywords (e.g., “unlock,” “start engine,” “play music,” “display weather forecast,” or another voice command) detected in the one or more enhanced mono audio signals 143, such as by providing feedback or information via a display 1720 or one or more speakers (e.g., the one or more speakers 722).

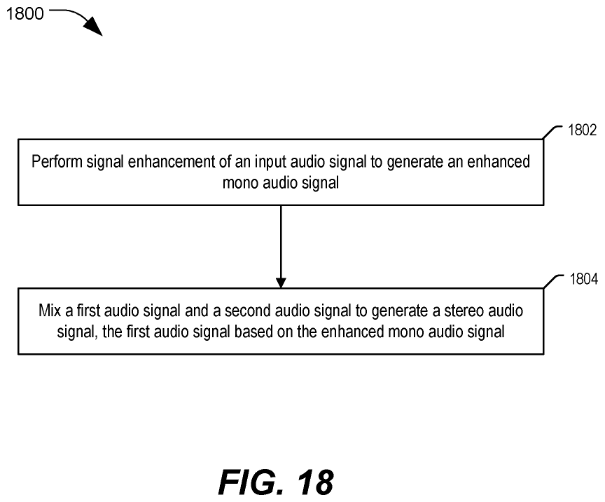

Referring to FIG. 18, a particular implementation of a method 1800 of audio signal enhancement is shown. In a particular aspect, one or more operations of the method 1800 are performed by at least one of the audio analyzer 140, the processor 190, the device 102, the system 100 of FIG. 1A, or a combination thereof.

The method 1800 includes performing signal enhancement of an input audio signal to generate an enhanced mono audio signal, at 1802. For example, the signal enhancer 142 of FIG. 1A generates the one or more enhanced mono audio signals 143, as described with reference to FIG. 1A.

The method 1800 also includes mixing a first audio signal and a second audio signal to generate a stereo audio signal, the first audio signal is based on the enhanced mono audio signal, at 1804. For example, the audio mixer 148 mixes the one or more enhanced audio signals 151 and the one or more audio signals 155 to generate the one or more stereo audio signals 149, as described with reference to FIG. 1A. The one or more enhanced audio signals 151 are based on the one or more enhanced mono audio signals 143.

The method 1800 balances signal enhancement of the enhanced mono audio signal with directional context associated with the second audio signals in generating the stereo audio signal. For example, the one or more stereo audio signals 149 can include directional noise or reverberation that provides audio context to a listener while removing at least some of the background noise (e.g., diffuse noise or all background noise).

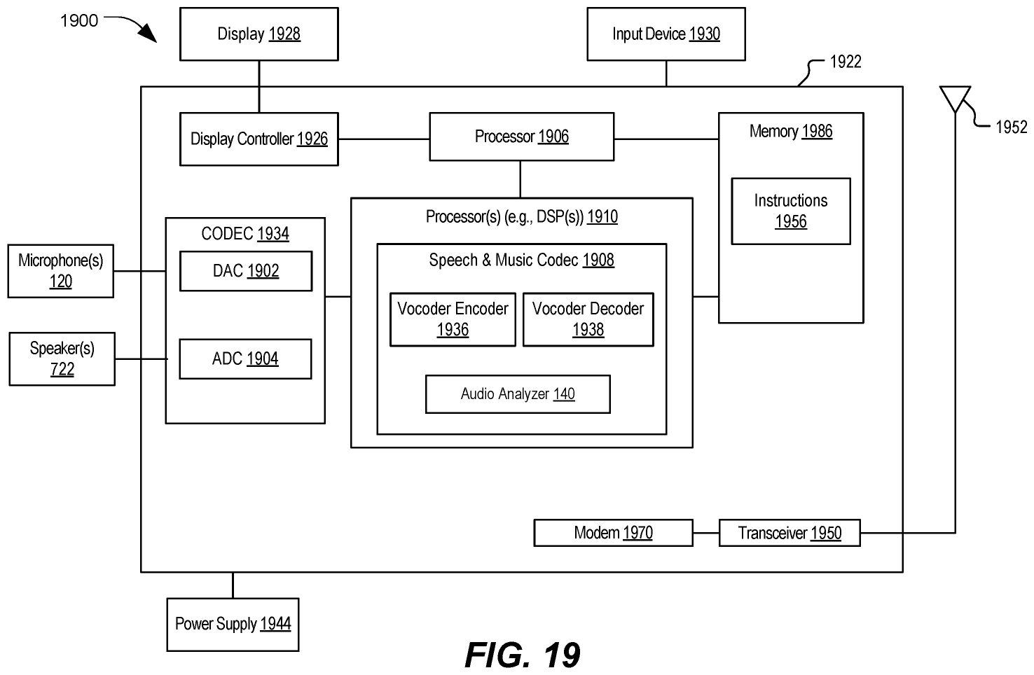

The method 1800 of FIG. 18 may be implemented by a field-programmable gate array (FPGA) device, an application-specific integrated circuit (ASIC), a processing unit such as a central processing unit (CPU), a digital signal processor (DSP), a graphics processing unit (GPU), a controller, another hardware device, firmware device, or any combination thereof. As an example, the method 1800 of FIG. 18 may be performed by a processor that executes instructions, such as described with reference to FIG. 19.

Referring to FIG. 19, a block diagram of a particular illustrative implementation of a device is depicted and generally designated 1900. In various implementations, the device 1900 may have more or fewer components than illustrated in FIG. 19. In an illustrative implementation, the device 1900 may correspond to the device 102. In an illustrative implementation, the device 1900 may perform one or more operations described with reference to FIGS. 1A-18.

In a particular implementation, the device 1900 includes a processor 1906 (e.g., a CPU). The device 1900 may include one or more additional processors 1910 (e.g., one or more DSPs, one or more GPUs, or a combination thereof). In a particular aspect, the one or more processors 190 of FIG. 1A correspond to the processor 1906, the processors 1910, or a combination thereof. The processors 1910 may include a speech and music coder-decoder (CODEC) 1908 that includes a voice coder (“vocoder”) encoder 1936, a vocoder decoder 1938, the audio analyzer 140, or a combination thereof.

The device 1900 may include a memory 1986 and a CODEC 1934. The memory 1986 may include instructions 1956, that are executable by the one or more additional processors 1910 (or the processor 1906) to implement the functionality described with reference to the audio analyzer 140. The device 1900 may include a modem 1970 coupled, via a transceiver 1950, to an antenna 1952.

The device 1900 may include a display 1928 coupled to a display controller 1926. The one or more speakers 722, the one or more microphones 120, or a combination thereof may be coupled to the CODEC 1934. The CODEC 1934 may include a digital-to-analog converter (DAC) 1902, an analog-to-digital converter (ADC) 1904, or both. In a particular implementation, the CODEC 1934 may receive analog signals from the one or more microphones 120, convert the analog signals to digital signals using the analog-to-digital converter 1904, and provide the digital signals to the speech and music codec 1908. The speech and music codec 1908 may process the digital signals, and the digital signals may further be processed by the audio analyzer 140. In a particular implementation, the speech and music codec 1908 may provide digital signals to the CODEC 1934. The CODEC 1934 may convert the digital signals to analog signals using the digital-to-analog converter 1902 and may provide the analog signals to the one or more speakers 722.

In a particular implementation, the device 1900 may be included in a system-in-package or system-on-chip device 1922. In a particular implementation, the memory 1986, the processor 1906, the processors 1910, the display controller 1926, the CODEC 1934, and the modem 1970 are included in the system-in-package or system-on-chip device 1922. In a particular implementation, an input device 1930 and a power supply 1944 are coupled to the system-in-package or the system-on-chip device 1922. Moreover, in a particular implementation, as illustrated in FIG. 19, the display 1928, the input device 1930, the one or more speakers 722, the one or more microphones 120, the antenna 1952, and the power supply 1944 are external to the system-in-package or the system-on-chip device 1922. In a particular implementation, each of the display 1928, the input device 1930, the one or more speakers 722, the one or more microphones 120, the antenna 1952, and the power supply 1944 may be coupled to a component of the system-in-package or the system-on-chip device 1922, such as an interface or a controller.

The device 1900 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for performing signal enhancement of an input audio signal to generate an enhanced mono audio signal. For example, the means for performing the signal enhancement can correspond to the neural network 152, the signal enhancer 142, the audio mixer 148, the audio analyzer 140, the one or more processors 190, the device 102, the system 100 of FIG. 1A, one or more other circuits or components configured to perform signal enhancement, or any combination thereof.

The apparatus also includes means for mixing the first audio signal and the second audio signal to generate a stereo audio signal, the first audio signal based on the enhanced mono audio signal. For example, the means for mixing can correspond to the audio mixer 148, the audio analyzer 140, the one or more processors 190, the device 102, the system 100 of FIG. 1A, the audio mixer 148A of FIGS. 2A, 3A, 4A, 5A, and 6A, the audio mixer 148B of FIGS. 2B, 3B, 4B, 5B, and 6B, the neural network of any of FIGS. 2C, 3C, 4C, 5C, or 6C, one or more other circuits or components configured to mix the first audio signal and the second audio signal, or any combination thereof.

In some implementations, a non-transitory computer-readable medium (e.g., a computer-readable storage device, such as the memory 1986) includes instructions (e.g., the instructions 1956) that, when executed by one or more processors (e.g., the one or more processors 1910 or the processor 1906), cause the one or more processors to perform signal enhancement of an input audio signal (e.g., the one or more input audio signals 125) to generate an enhanced mono audio signal (e.g., the one or more enhanced mono audio signals 143). The instructions, when executed by the one or more processors, also cause the one or more processors to mix a first audio signal (e.g., the one or more enhanced audio signals 151) and a second audio signal (e.g., the one or more audio signals 155) to generate a stereo audio signal (e.g., the one or more stereo audio signals 149). The first audio signal is based on the enhanced mono audio signal.

Particular aspects of the disclosure are described below in sets of interrelated Examples:

According to Example 1, a device includes: a processor configured to perform signal enhancement of an input audio signal to generate an enhanced mono audio signal; and mix a first audio signal and a second audio signal to generate a stereo audio signal, the first audio signal based on the enhanced mono audio signal.

Example 2 includes the device of Example 1, wherein the second audio signal is associated with a context of the input audio signal.

Example 3 includes the device of Example 1 or Example 2, wherein the processor is configured to use a neural network to perform the signal enhancement.

Example 4 includes the device of any of Example 1 to Example 3, wherein the input audio signal is based on microphone output of one or more microphones.

Example 5 includes the device of any of Example 1 to Example 4, wherein the processor is configured to decode encoded audio data to generate the input audio signal.

Example 6 includes the device of any of Example 1 to Example 5, wherein the signal enhancement includes at least one of noise suppression, audio zoom, beamforming, dereverberation, source separation, bass adjustment, or equalization.

Example 7 includes the device of any of Example 1 to Example 6, wherein the signal enhancement is based at least in part on a configuration setting, a user input, or both.

Example 8 includes the device of any of Example 1 to Example 7, wherein the processor is configured to use a neural network to mix the first audio signal and the second audio signal to generate the stereo audio signal.

Example 9 includes the device of any of Example 1 to Example 8, wherein the processor is configured to: use a first neural network to perform signal enhancement of an input audio signal to generate the enhanced mono audio signal; and use a second neural network to mix the first audio signal and the second audio signal.

Example 10 includes the device of any of Example 1 to Example 9, wherein the processor is configured to: perform signal enhancement of a second input audio signal to generate a second enhanced mono audio signal; and generate the stereo audio signal based on mixing the first audio signal, the second audio signal, and a third audio signal, the third audio signal based on the second enhanced mono audio signal.

Example 11 includes the device of any of Example 1 to Example 10, wherein the processor is configured to generate at least one directional audio signal based on the input audio signal; and wherein the second audio signal is based on the at least one directional audio signal.

Example 12 includes the device of any of Example 1 to Example 11, wherein the processor is configured to: generate a directional audio signal based on the input audio signal; and apply a delay to the directional audio signal to generate a delayed audio signal, wherein the second audio signal is based on the delayed audio signal.

Example 13 includes the device of Example 12, wherein the processor is configured to pan, based on a visual context, the delayed audio signal to generate the second audio signal.

Example 14 includes the device of any of Example 1 to Example 13, wherein the processor is configured to pan the enhanced mono audio signal to generate the first audio signal.

Example 15 includes the device of Example 14, wherein the processor is configured to receive a user selection of an audio source direction, and wherein the enhanced mono audio signal is panned based on the audio source direction.

Example 16 includes the device of Example 15, wherein the processor is configured to determine the user selection based on hand gesture detection, head tracking, eye gaze detection, a user interface input, or a combination thereof.

Example 17 includes the device of Example 15 or Example 16, wherein the processor is configured to apply, based on the audio source direction, a head-related transfer function (HRTF) to the enhanced mono audio signal to generate the first audio signal.

Example 18 includes the device of any of Example 1 to Example 17, wherein the processor is configured to generate a background audio signal from an input audio signal, wherein the second audio signal is based at least in part on the background audio signal.

Example 19 includes the device of Example 18, wherein the processor is configured to: apply a delay to the background audio signal to generate a delayed background audio signal; and attenuate the delayed background audio signal to generate the second audio signal.

Example 20 includes the device of Example 19, wherein the processor is configured to attenuate the delayed background audio signal based on a visual context to generate the second audio signal.

Example 21 includes the device of any of Example 18 to Example 20, wherein the processor is configured to: generate at least one directional audio signal from the input audio signal; and use a reverberation model to process the background audio signal, the at least one directional audio signal, or a combination thereof, to generate a reverberation signal, wherein the second audio signal includes the reverberation signal.

Example 22 includes the device of any of Example 1 to Example 20, wherein the processor is configured to: determine, based on image data, a visual context of the input audio signal, the image data representing a visual scene associated with an audio source of the input audio signal; and use a reverberation model to generate a synthesized reverberation signal corresponding to the visual context, wherein the second audio signal includes the synthesized reverberation signal.

Example 23 includes the device of Example 22, wherein the visual context is based on surfaces of an environment, room geometry, or both.

Example 24 includes the device of Example 22 or Example 23, wherein the image data is based on at least one of camera output, a graphic visual stream, decoded image data, or stored image data.

Example 25 includes the device of any of Example 22 to Example 24, wherein the processor is configured to determine the visual context based at least in part on performing face detection on the image data.

Example 26 includes the device of any of Example 1 to Example 20, wherein the processor is configured to: determine a location context based on location data; and use a reverberation model to generate a synthesized reverberation signal corresponding to the location context, wherein the second audio signal includes the synthesized reverberation signal.

According to Example 27, a method includes: performing, at a device, signal enhancement of an input audio signal to generate an enhanced mono audio signal; and mixing, at the device, a first audio signal and a second audio signal to generate a stereo audio signal, the first audio signal based on the enhanced mono audio signal.

Example 28 includes the method of Example 27, wherein the second audio signal is associated with a context of the input audio signal.

Example 29 includes the method of Example 27 or Example 28, further including using a neural network to perform the signal enhancement.

Example 30 includes the method of any of Example 27 to Example 29, wherein the input audio signal is based on microphone output of one or more microphones.

Example 31 includes the method of any of Example 27 to Example 30, further including decoding encoded audio data to generate the input audio signal.

Example 32 includes the method of any of Example 27 to Example 31, wherein the signal enhancement includes at least one of noise suppression, audio zoom, beamforming, dereverberation, source separation, bass adjustment, or equalization.

Example 33 includes the method of any of Example 27 to Example 32, wherein the signal enhancement is based at least in part on a configuration setting, a user input, or both.

Example 34 includes the method of any of Example 27 to Example 33, further including using a neural network to mix the first audio signal and the second audio signal to generate the stereo audio signal.

Example 35 includes the method of any of Example 27 to Example 34, further including: using a first neural network to perform signal enhancement of an input audio signal to generate the enhanced mono audio signal; and using a second neural network to mix the first audio signal and the second audio signal.

Example 36 includes the method of any of Example 27 to Example 35, further including: performing signal enhancement of a second input audio signal to generate a second enhanced mono audio signal; and generating the stereo audio signal based on mixing the first audio signal, the second audio signal, and a third audio signal, the third audio signal based on the second enhanced mono audio signal.

Example 37 includes the method of any of Example 27 to Example 36, further including generating at least one directional audio signal based on the input audio signal; and wherein the second audio signal is based on the at least one directional audio signal.

Example 38 includes the method of any of Example 27 to Example 37, further including: generating a directional audio signal based on the input audio signal; and applying a delay to the directional audio signal to generate a delayed audio signal, wherein the second audio signal is based on the delayed audio signal.

Example 39 includes the method of Example 38, further including panning, based on a visual context, the delayed audio signal to generate the second audio signal.

Example 40 includes the method of any of Example 27 to Example 39, further including panning the enhanced mono audio signal to generate the first audio signal.

Example 41 includes the method of Example 40, further including: receiving a user selection of an audio source direction, wherein the enhanced mono audio signal is panned based on the audio source direction.

Example 42 includes the method of Example 41, further including determining the user selection based on hand gesture detection, head tracking, eye gaze detection, a user interface input, or a combination thereof.

Example 43 includes the method of Example 41 or Example 42, further including applying, based on the audio source direction, a head-related transfer function (HRTF) to the enhanced mono audio signal to generate the first audio signal.

Example 44 includes the method of any of Example 27 to Example 43, further including generating a background audio signal from an input audio signal, wherein the second audio signal is based at least in part on the background audio signal.

Example 45 includes the method of Example 44, further including: applying a delay to the background audio signal to generate a delayed background audio signal; and attenuating the delayed background audio signal to generate the second audio signal.

Example 46 includes the method of Example 45, further including attenuating the delayed background audio signal based on a visual context to generate the second audio signal.

Example 47 includes the method of any of Example 44 to Example 46, further including: generating at least one directional audio signal from the input audio signal; and using a reverberation model to process the background audio signal, the at least one directional audio signal, or a combination thereof, to generate a reverberation signal, wherein the second audio signal includes the reverberation signal.

Example 48 includes the method of any of Example 27 to Example 46, further including: determining, based on image data, a visual context of the input audio signal, the image data representing a visual scene associated with an audio source of the input audio signal; and using a reverberation model to generate a synthesized reverberation signal corresponding to the visual context, wherein the second audio signal includes the synthesized reverberation signal.

Example 49 includes the method of Example 48, wherein the visual context is based on surfaces of an environment, room geometry, or both.

Example 50 includes the method of Example 48 or Example 49, wherein the image data is based on at least one of camera output, a graphic visual stream, decoded image data, or stored image data.

Example 51 includes the method of any of Example 48 to Example 50, further including determining the visual context based at least in part on performing face detection on the image data.

Example 52 includes the method of any of Example 27 to Example 46, further including: determining a location context based on location data; and using a reverberation model to generate a synthesized reverberation signal corresponding to the location context, wherein the second audio signal includes the synthesized reverberation signal.

According to Example 53, a device includes: a memory configured to store instructions; and a processor configured to execute the instructions to perform the method of any of Example 27 to Example 52.

According to Example 54, a non-transitory computer-readable medium stores instructions that, when executed by a processor, cause the processor to perform the method of any of Example 27 to Example 52.

According to Example 55, an apparatus includes means for carrying out the method of any of Example 27 to Example 52.

According to Example 56, a non-transitory computer-readable medium stores instructions that, when executed by one or more processors, cause the one or more processors to: perform signal enhancement of an input audio signal to generate the enhanced mono audio signal; and mix a first audio signal and a second audio signal to generate a stereo audio signal, the first audio signal based on the enhanced mono audio signal.

Example 57 includes the non-transitory computer-readable medium of Example 56, wherein the second audio signal is associated with a context of the input audio signal.

According to Example 58, an apparatus includes: means for performing signal enhancement of an input audio signal to generate the enhanced mono audio signal; and means for mixing a first audio signal and a second audio signal to generate a stereo audio signal, the first audio signal based on the enhanced mono audio signal.

Example 59 includes the apparatus of Example 58, wherein the means for performing the signal enhancement, and the means for mixing the first audio signal and the second audio signal are integrated into at least one of a smart speaker, a speaker bar, a computer, a tablet, a display device, a television, a gaming console, a music player, a radio, a digital video player, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a communication device, an internet-of-things (IoT) device, a virtual reality (VR) device, a base station, or a mobile device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a processor configured to:
perform signal enhancement of an input audio signal to generate an enhanced mono audio signal; and
mix a first audio signal and a second audio signal to generate a stereo audio signal, the first audio signal based on the enhanced mono audio signal.

2. The device of claim 1, wherein the second audio signal is associated with a context of the input audio signal.

3. The device of claim 1, wherein the processor is configured to use a neural network to perform the signal enhancement.

4. The device of claim 1, wherein the input audio signal is based on microphone output of one or more microphones.

5. The device of claim 1, wherein the processor is configured to decode encoded audio data to generate the input audio signal.

6. The device of claim 1, wherein the signal enhancement includes at least one of noise suppression, audio zoom, beamforming, dereverberation, source separation, bass adjustment, or equalization.

7. The device of claim 1, wherein the processor is configured to use a neural network to mix the first audio signal and the second audio signal to generate the stereo audio signal.

8. The device of claim 1, wherein the processor is configured to:
use a first neural network to perform signal enhancement of an input audio signal to generate the enhanced mono audio signal; and
use a second neural network to mix the first audio signal and the second audio signal.

9. The device of claim 1, wherein the processor is configured to:
perform signal enhancement of a second input audio signal to generate a second enhanced mono audio signal; and
generate the stereo audio signal based on mixing the first audio signal, the second audio signal, and a third audio signal, the third audio signal based on the second enhanced mono audio signal.

10. The device of claim 1, wherein the processor is configured to generate at least one directional audio signal based on the input audio signal, and wherein the second audio signal is based on the at least one directional audio signal.

11. The device of claim 1, wherein the processor is configured to:
generate a directional audio signal based on the input audio signal; and
apply a delay to the directional audio signal to generate a delayed audio signal, wherein the second audio signal is based on the delayed audio signal.

12. The device of claim 11, wherein the processor is configured to pan, based on a visual context, the delayed audio signal to generate the second audio signal.

13. The device of claim 1, wherein the processor is configured to pan the enhanced mono audio signal to generate the first audio signal.

14. The device of claim 13, wherein the processor is configured to receive a user selection of an audio source direction, and wherein the enhanced mono audio signal is panned based on the audio source direction.

15. The device of claim 14, wherein the processor is configured to determine the user selection based on hand gesture detection, head tracking, eye gaze detection, a user interface input, or a combination thereof.

16. The device of claim 14, wherein the processor is configured to apply, based on the audio source direction, a head-related transfer function (HRTF) to the enhanced mono audio signal to generate the first audio signal.

17. The device of claim 1, wherein the processor is configured to generate a background audio signal from an input audio signal, wherein the second audio signal is based at least in part on the background audio signal.

18. The device of claim 17, wherein the processor is configured to:
apply a delay to the background audio signal to generate a delayed background audio signal; and
attenuate the delayed background audio signal to generate the second audio signal.

19. The device of claim 18, wherein the processor is configured to attenuate the delayed background audio signal based on a visual context to generate the second audio signal.

20. The device of claim 17, wherein the processor is configured to:
generate at least one directional audio signal from the input audio signal; and
use a reverberation model to process the background audio signal, the at least one directional audio signal, or a combination thereof, to generate a reverberation signal, wherein the second audio signal includes the reverberation signal.

21. The device of claim 1, wherein the processor is configured to:
determine, based on image data, a visual context of the input audio signal, the image data representing a visual scene associated with an audio source of the input audio signal; and
use a reverberation model to generate a synthesized reverberation signal corresponding to the visual context, wherein the second audio signal includes the synthesized reverberation signal.

22. The device of claim 21, wherein the visual context is based on surfaces of an acoustic environment, room geometry, or both.

23. The device of claim 21, wherein the image data is based on at least one of camera output, a graphic visual stream, decoded image data, or stored image data.

24. The device of claim 21, wherein the processor is configured to determine the visual context based at least in part on performing face detection on the image data.

25. A method comprising:
performing, at a device, signal enhancement of an input audio signal to generate an enhanced mono audio signal; and
mixing, at the device, a first audio signal and a second audio signal to generate a stereo audio signal, the first audio signal based on the enhanced mono audio signal.

26. The method of claim 25, further comprising:
determining a location context based on location data; and
using a reverberation model to generate a synthesized reverberation signal corresponding to the location context, wherein the second audio signal includes the synthesized reverberation signal.

27. A non-transitory computer-readable medium storing instructions that, when executed by one or more processors, cause the one or more processors to:
perform signal enhancement of an input audio signal to generate an enhanced mono audio signal; and
mix a first audio signal and a second audio signal to generate a stereo audio signal, the first audio signal based on the enhanced mono audio signal.

28. The non-transitory computer-readable medium of claim 27, wherein the signal enhancement is based at least in part on a configuration setting, a user input, or both.

29. An apparatus comprising:
means for performing signal enhancement of an input audio signal to generate an enhanced mono audio signal; and
means for mixing a first audio signal and a second audio signal to generate a stereo audio signal, the first audio signal based on the enhanced mono audio signal.

30. The apparatus of claim 29, wherein the means for performing the signal enhancement and the means for mixing the first audio signal and the second audio signal are integrated into at least one of a smart speaker, a speaker bar, a computer, a tablet, a display device, a television, a gaming console, a music player, a radio, a digital video player, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a communication device, an internet-of-things (IoT) device, a virtual reality (VR) device, a base station, or a mobile device.
